(19) United States
(12) Patent Application Publication
(10) Pub. No.: US 2026/0277972 A1
(43) Pub. Date: Sep. 17, 2026

(54) PIPELINE CONFIGURATION AND MODULAR PROCESSING FOR RETRIEVAL-AUGMENTED GENERATION

(71) Applicant: NVIDIA Corporation, Santa Clara, CA (US)

(72) Inventors: Julien VERON VIALARD, San Francisco, CA (US); Aditya Uday MALTE, San Jose, CA (US); Vinay RAMAN, San Jose, CA (US); Nikhil SRIHARI, Bothell, WA (US); Suseella PANGULURI, Dublin, CA (US); Eileen Margaret Peters LONG, San Jose, CA (US)

(73) Assignee: NVIDIA Corporation, Santa Clara, CA (US)

(21) Appl. No.: 19/190,102

(22) Filed: Apr. 25, 2025

Related U.S. Application Data
(60) Provisional application No. 63/771,872, filed on Mar. 14, 2025.

(51) Int. Cl. G06F 16/334; G06F 11/34; G06F 16/31

(52) U.S. Cl. CPC G06F 16/3347; G06F 16/316

(57) ABSTRACT

Various examples, systems, and methods relate to configuring, executing, and evaluating retrieval-augmented generation (RAG) pipelines. A system can process a configuration dataset defining a pipeline and an evaluation dataset containing content and queries. The system can generate vector embeddings of content using an artificial intelligence (AI) model within the RAG pipeline. The system can retrieve candidate content from a database by performing a comparison between the representations of the query and the stored content. The system can compute a performance measurement based on the retrieved candidate content and provide the measurement as output.

### CROSS-REFERENCE TO RELATED APPLICATIONS

The present application claims the benefit of U.S. Provisional Patent Application No. 63/771,872, filed Mar. 14, 2025, the disclosure of which is incorporated herein by reference in its entirety.

### BACKGROUND

Evaluating retrieval-augmented generation (RAG) pipelines for dynamic data sources presents challenges. Some existing systems rely on partially automated workflows, requiring manual intervention for tasks such as pipeline configuration or module selection (e.g., embedding model, reranker, large language model). These systems often produce results focused on one stage of the pipeline, resulting in limited adaptability and incomplete coverage of end-to-end operations. Many existing solutions are inadequate for providing modular evaluations that accommodate changes in data, pipeline components, and/or performance objectives, instead rely on static codebases and/or infrequent updates. These limitations prevent systems from performing modular updates in real time, restrict reconfiguration for new data inputs, and restrict updates to retrieval-augmented generation pipelines.

### SUMMARY

Implementations of the present disclosure relate to systems and methods for orchestrating, configuring, and/or evaluating RAG pipelines on a modular, switchable basis. For example, systems and methods in accordance with the present disclosure can receive a user configuration referencing one or more pipeline templates in a markup language (e.g., YAML, JSON, TOML, and/or any structured configuration format). That is, at least one (e.g., each) template can identify an embedding model, a reranking model, a large language model, a pipeline orchestrator, a vector indexing configuration, and/or any data transformation component. That is, the systems and methods can be used to generate embeddings, retrieve candidate documents, reorder those documents, output answers, and/or determine one or more performance metrics (e.g., retrieval scores, answer correctness measures, a semantic similarity score, a classification accuracy metric, and/or any pipeline evaluation metric). In some implementations, the systems and methods can perform asynchronous and/or parallel processing of datasets to efficiently index content in a vector database. Additionally, different pipeline combinations can be tested or updated without updating a monolithic codebase. These implementations provide dynamic evaluations for multiple pipeline configurations, supporting real-time or near real-time comparisons and iterative tuning of components and/or hyperparameters. By using distributed data sources, template-based orchestration, and/or metric generation, the systems improve pipeline adaptability and/or end-to-end RAG evaluations.

Some implementations relate to a system. Some implementations relate to one or more processors to obtain a configuration dataset and an evaluation dataset, the configuration dataset identifying a pipeline and the evaluation dataset including a set of content and at least one query. The one or more processors are to generate, using a first artificial intelligence (AI) model of the pipeline, a plurality of embeddings of the set of content. The one or more processors are to retrieve, from a vector database, at least one candidate content from the plurality of embeddings based at least on a similarity metric between the at least one candidate content and the at least one query. The one or more processors are to determine a performance metric based at least on the retrieved at least one candidate content. The one or more processors are to provide the performance metric.

In some implementations, the configuration dataset identifies at least one configuration template to implement the pipeline. In some implementations, the first AI model is identified from the at least one configuration template. In some implementations, the one or more processors are to store the plurality of embeddings in the vector database. In some implementations, generating the plurality of embeddings includes generating a vector index for the set of content. In some implementations, the one or more processors are to generate, using the first AI model, a plurality of query embeddings representing the at least one query. In some implementations, the at least one candidate content is retrieved based at least on the similarity metric determined between the plurality of query embeddings and the plurality of embeddings stored in the vector database.

In some implementations, the at least one candidate content includes a plurality of candidate content. In some implementations, the one or more processors are to update, using a second AI model, an order of the plurality of candidate content based at least on ranking the plurality of candidate content using at least one of (i) a vector similarity metric, (ii) query relevance metric, (iii) retrieval confidence metric, or (iv) aggregation metric. In some implementations, the one or more processors are to apply the at least one candidate content and the at least one query as input to a third AI model of the pipeline to cause the third AI model to generate an output. In some implementations, generating the performance metric is further based on the output and corresponding ground truth data.

In some implementations, the one or more processors are to generate, based on the configuration dataset, a plurality of pipeline configurations, at least one pipeline configuration of the plurality of pipeline configurations including at least one of the first AI model, the second AI model, or the third AI model. In some implementations, the one or more processors are to perform at least one pipeline modeling job corresponding to at least one of the plurality of pipeline configurations. In some implementations, the one or more processors are to determine, for the at least one pipeline modeling job, the performance metric corresponding to the retrieved at least one candidate content or the output generated by the third AI model. In some implementations, the one or more processors are to update at least one of the plurality of pipeline configurations based at least on the performance metric across the plurality of pipeline configurations.

In some implementations, the one or more processors are to receive, from a user device, a status request corresponding to a pipeline modeling job. In some implementations, the one or more processors are to determine a status of the pipeline modeling job. In some implementations, the one or more processors are to provide, to the user device, the status.

Some implementations relate to one or more processors including processing circuitry to obtain a configuration dataset and an evaluation dataset, the configuration dataset identifying a pipeline and the evaluation dataset including a set of content and at least one query. The processing circuitry to generate, using a first artificial intelligence (AI) model of the pipeline, a plurality of embeddings of the set of content. The processing circuitry to retrieve, from a vector database, at least one candidate content from the plurality of embeddings based at least on a similarity metric between the at least one candidate content and the at least one query. The processing circuitry to determine a performance metric based at least on the retrieved at least one candidate content. The processing circuitry to provide the performance metric.

In some implementations, the configuration dataset identifies at least one configuration template to implement the pipeline. In some implementations, the first AI model is identified from the at least one configuration template. In some implementations, the processing circuitry to store the plurality of embeddings in the vector database. In some implementations, generating the plurality of embeddings includes generating a vector index for the set of content. In some implementations, the processing circuitry to generate, using the first AI model, a plurality of query embeddings representing the at least one query. In some implementations, the at least one candidate content is retrieved based at least on the similarity metric determined between the plurality of query embeddings and the plurality of embeddings stored in the vector database.

In some implementations, the at least one candidate content includes a plurality of candidate content. In some implementations, the processing circuitry to update, using a second AI model, an order of the plurality of candidate content based at least on ranking the plurality of candidate content using at least one of (i) a vector similarity metric, (ii) query relevance metric, (iii) retrieval confidence metric, or (iv) aggregation metric. In some implementations, the processing circuitry to apply the at least one candidate content and the at least one query as input to a third AI model of the pipeline to cause the third AI model to generate an output. In some implementations, generating the performance metric is further based on the output and corresponding ground truth data.

In some implementations, the processing circuitry to generate, based on the configuration dataset, a plurality of pipeline configurations, at least one pipeline configuration of the plurality of pipeline configurations including at least one of the first AI model, the second AI model, or the third AI model. In some implementations, the processing circuitry to perform at least one pipeline modeling job corresponding to at least one of the plurality of pipeline configurations. In some implementations, the processing circuitry to determine, for the at least one pipeline modeling job, the performance metric corresponding to the retrieved at least one candidate content or the output generated by the third AI model. In some implementations, the processing circuitry to update at least one of the plurality of pipeline configurations based at least on the performance metric across the plurality of pipeline configurations.

In some implementations, the processing circuitry to receive, from a user device, a status request corresponding to a pipeline modeling job. In some implementations, the processing circuitry to determine a status of the pipeline modeling job. In some implementations, the processing circuitry to provide, to the user device, the status.

Some implementations relate to a method. The method includes obtaining, by one or more processors, a configuration dataset and an evaluation dataset, the configuration dataset identifying a pipeline and the evaluation dataset including a set of content and at least one query. The method includes generating, by the one or more processors using a first artificial intelligence (AI) model of the pipeline, a plurality of embeddings of the set of content. The method includes retrieving, by the one or more processors from a vector database, at least one candidate content from the plurality of embeddings based at least on a similarity metric between the at least one candidate content and the at least one query. The method includes determining, by the one or more processors, a performance metric based at least on the retrieved at least one candidate content. The method includes providing, by the one or more processors, the performance metric.

In some implementations, the configuration dataset identifies at least one configuration template to implement the pipeline. In some implementations, the first AI model is identified from the at least one configuration template. In some implementations, the method includes storing the plurality of embeddings in the vector database. In some implementations, generating the plurality of embeddings includes generating a vector index for the set of content.

The processors, systems, and/or methods described herein can be implemented by or included in at least one a system. The system can include a system for performing one or more retrieval-augmented generation (RAG) pipelines; a system for tuning one or more processing architectures; a system for updating one or more processing configurations; a system for implementing distributed or concurrent processing operations; a system implementing one or more multi-model language models (MMLMs); a system implementing one or more large language models (LLMs); a system implementing one or more small language models (SLMs); a system implementing one or more vision language models (VLMs); a system for generating synthetic data; a system for generating synthetic data using AI; a control system for an autonomous or semi-autonomous machine; a perception system for an autonomous or semi-autonomous machine; a system for performing digital twin operations; a system for performing light transport simulation; a system for performing remote operations; a system implemented using an edge device; a system implemented using a robot; a system for performing conversational AI operations; a system incorporating one or more virtual machines (VMs); a system implemented at least partially in a data center; or a system implemented at least partially using cloud computing resources.

### BRIEF DESCRIPTION OF THE DRAWINGS

The present systems and methods for pipeline configuration and modular processing for retrieval-augmented generation are described in detail below with reference to the attached drawing figures, wherein:

FIG. 1 is a block diagram of an example of a system, in accordance with some implementations of the present disclosure;

FIG. 2 is a flow diagram of an example of a method for pipeline configuration and modular processing for retrieval-augmented generation in a retrieval pipeline, in accordance with some implementations of the present disclosure;

FIG. 3 is a block diagram of an example of the retrieval pipeline, in accordance with some implementations of the present disclosure;

FIG. 4A is a block diagram of an example generative language model system suitable for use in implementing at least some implementations of the present disclosure;

FIG. 4B is a block diagram of an example generative language model that includes a transformer encoder-decoder suitable for use in implementing at least some implementations of the present disclosure;

FIG. 4C is a block diagram of an example generative language model that includes a decoder-only transformer architecture suitable for use in implementing at least some implementations of the present disclosure;

FIG. 5 is a block diagram of an example computing device suitable for use in implementing at least some implementations of the present disclosure;

FIG. 6 is a block diagram of an example data center suitable for use in implementing at least some implementations of the present disclosure.

### DETAILED DESCRIPTION

This disclosure relates to systems and methods for configuring, executing, and evaluating retrieval-augmented generation (RAG) pipelines using a modular framework that supports adaptive processing configurations. For example, systems and methods in accordance with the present disclosure facilitate dynamic selection of retrieval, ranking, and/or generation models based on structured pipeline configurations. These configurations can specify pipeline components (e.g., retriever models, rerankers, large language models) and/or allow processing configurations to be modified without altering underlying pipeline logic. That is, dynamically configuring pipeline execution can involve modifying retrieval, ranking, and/or generation parameters based on performance evaluation, supporting adaptive pipeline management.

Some techniques for implementing RAG pipelines rely on predefined static architectures where retrieval, ranking, and generation processes are fixed within monolithic workflows, limiting adaptability. These approaches often require modifying structured indexing and/or retrieval logic when tuning pipeline components, leading to inefficiencies when testing multiple pipeline configurations. Additionally, existing systems often assess retrieval and/or response generation separately, preventing a unified assessment of the overall performance of the pipeline. Some methods also do not support concurrent indexing and querying, limiting efficiency when processing large datasets. The limitations relate to how these systems manage pipeline customization, retrieval evaluation, and/or large-scale processing. For example, rigid retrieval architectures prevent dynamic model selection, making it difficult to modify retrieval effectiveness. The inability to modify ranking and generation models independently restricts evaluation workflows. Additionally, static indexing structures often require reprocessing when modifying retrieval models, reducing flexibility when refining pipeline configurations. The improved implementations described herein provide modular pipeline execution, allowing retrieval and ranking models to be structured independently while maintaining efficient indexing and retrieval operations.

Systems and methods in accordance with the present disclosure provide improvements in retrieval-augmented generation (RAG) pipelines by supporting modular configurations, adaptive model selection, and/or dynamic indexing strategies. For example, pipeline components (e.g., retrievers, rerankers, and/or language models) can be updated using structured configuration datasets, allowing for flexible processing based on retrieval performance and response quality. The system supports parallel and asynchronous execution of retrieval and ranking operations, improving computational efficiency when handling large-scale data sources. Additionally, pipeline evaluation can be conducted iteratively, allowing structured modifications to retrieval and/or ranking processes based on computed performance metrics. The system can process structured evaluation pipelines to execute retrieval, ranking, and/or response generation across different configurations, supporting selection of pipeline components based on computed performance metrics. The system can interface with evaluation tools (e.g., job management systems, monitoring frameworks, and/or structured data storage systems) to store evaluation data, manage job execution, and/or monitor retrieval-augmented generation processes within an integrated execution environment.

In some implementations, the systems and methods can obtain a configuration dataset and an evaluation dataset. The configuration dataset can identify a pipeline (e.g., retrieval pipeline, retrieval-augmented generation (RAG) pipeline, ranking pipeline, hybrid retrieval pipeline, and/or any data processing pipeline) and the evaluation dataset can include a set of content, at least one query, and corresponding ground truth data. The systems and methods can generate a plurality of embeddings of the plurality of content based on using a first artificial intelligence (AI) model (e.g., embedding model) of the pipeline. Additionally, at least one candidate content can be retrieved from a vector database based at least on a similarity metric (e.g., cosine similarity, dot product similarity, Euclidean distance, and/or any distance-based similarity metric) between the at least one candidate content and the at least one query. For example, the query can be a natural language input or structured query corresponding to a topic, entity, or keyword, and the corresponding candidate content can be documents, passages, or structured data records stored in the vector database. In this example, the similarity metric can be cosine similarity exceeding a predefined threshold, indicating the retrieved candidate content is highly relevant to the query based on vector space proximity. In some implementations, the systems and methods can generate a performance metric based at least on the retrieved at least one candidate content. The performance metric can be a context recall metric, a context precision metric, a context relevance metric, and/or any retrieval effectiveness metric, ranking confidence metric, and/or semantic similarity metric.

Some implementations relate to updating an order of a plurality of retrieved candidate content using a second AI model (e.g., reranking model). That is, the order can be based at least on ranking the plurality of candidate content using at least one of a vector similarity metric, query relevance metric, retrieval confidence metric, and/or aggregation metric. In some implementations, the systems and methods can apply the at least one candidate content and the at least query as input to a third AI model (e.g., language model) of the pipeline to cause the third AI model to generate an output. Additionally, generating the performance metric is further based on the output and corresponding ground truth data.

The systems and methods can be further implemented to generate a plurality of pipeline configurations based on the configuration dataset. For example, at least one pipeline configuration of the plurality of pipeline configurations can include at least one of the first AI model, the second AI model, or the third AI model. The systems and methods can perform at least one pipeline modeling job corresponding to at least one of the plurality of pipeline configurations. That is, retrieval, reranking, and/or answer generation can be performed in parallel and/or asynchronously. Additionally, the performance metric can be determined for the at least one pipeline modeling job and a pipeline configuration can be updated based at least on the performance metric across the plurality of pipeline configurations. For example, the retriever model can be updated from being a dense retriever to sparse retriever based on retrieval performance scores indicating higher precision or recall for a sparse retrieval method in a given dataset domain.

The systems and methods described herein can be used for a variety of applications, such as information retrieval, document indexing, question answering, recommendation systems, automated knowledge extraction, real-time or near real-time data analysis, and/or any machine learning-driven data processing pipeline. For example, the systems can improve pipeline configurations for enterprise search engines, chatbot frameworks, and/or large-scale content curation systems. Additionally, the pipeline can provide technical improvements over traditional rule-based retrieval systems by allowing dynamic configuration, modular tuning of retrievers, and/or real-time or near real-time evaluation of pipeline effectiveness. These implementations address the limitations of traditional static retrieval and ranking systems by providing technical improvements in pipeline modularity, retrieval efficiency, and/or adaptive architecture tuning and/or scalability in evaluating multi-stage AI pipelines.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein can be packaged as a microservice—such an inference microservice (e.g., NVIDIA NIMs)—which can include a container (e.g., an operating system (OS)-level virtualization package) that can include an application programming interface (API) layer, a server layer, a runtime layer, and/or a model “engine.” For example, the inference microservice can include the container itself and the model(s) (e.g., weights and biases). In some instances, such as where the machine learning model(s) is small enough (e.g., has a small enough number of parameters), the model(s) can be included within the container itself. In other examples—such as where the model(s) is large—the model(s) can be hosted/stored in the cloud (e.g., in a data center) and/or can be hosted on-premises and/or at the edge (e.g., on a local server or computing device, but outside of the container). In such implementations, the model(s) can be accessible via one or more APIs—such as REST APIs. As such, and in some implementations, the machine learning model(s) described herein can be deployed as an inference microservice to accelerate deployment of a model(s) on any cloud, data center, or edge computing system, while ensuring the data is secure. For example, the inference microservice can include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which can include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein can be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice can include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some implementations, the inference microservice can include software to perform in-place replacement and/or updating to the machine learning model(s). When replacing or updating, the software that performs the replacement/updating can maintain user configurations of the inference runtime software and enterprise management software.

Although examples can be described herein with respect to using machine learning models, such as neural networks, this is not intended to be limiting. For example, and without limitation, any of the various machine learning models and/or neural networks described herein can include any type of machine learning model, such as a machine learning model(s) using linear regression, logistic regression, decision trees, support vector machines (SVM), Naive Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using M amba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein can be used by, without limitation, non-autonomous vehicles or machines, semi-autonomous vehicles or machines (e.g., in one or more adaptive driver assistance systems (ADAS)), autonomous vehicles or machines, piloted and unpiloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein can be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed implementations can be comprised in a variety of different systems such as automotive systems (e.g., a control system for an autonomous or semi-autonomous machine, a perception system for an autonomous or semi-autonomous machine, etc.), systems implemented using a robot, aerial systems, medical systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

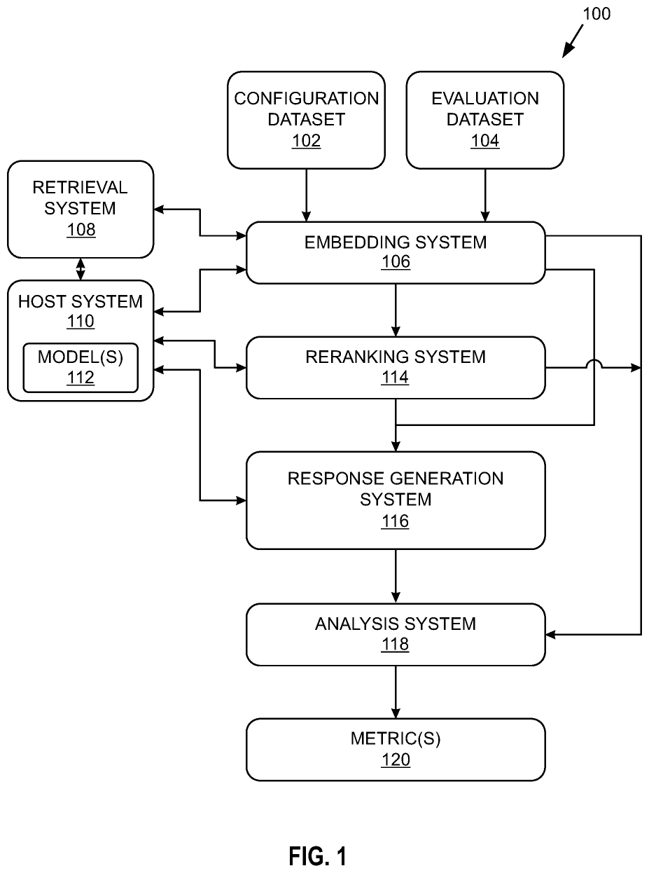

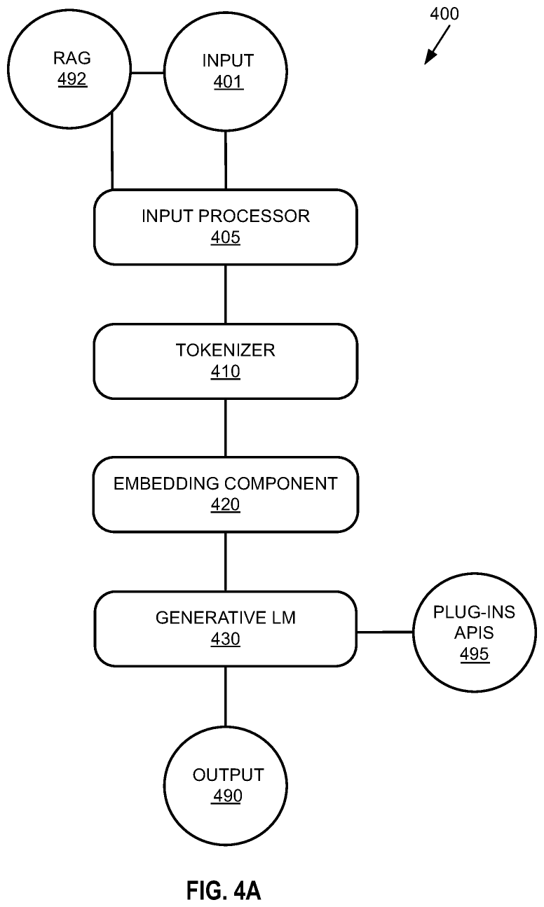

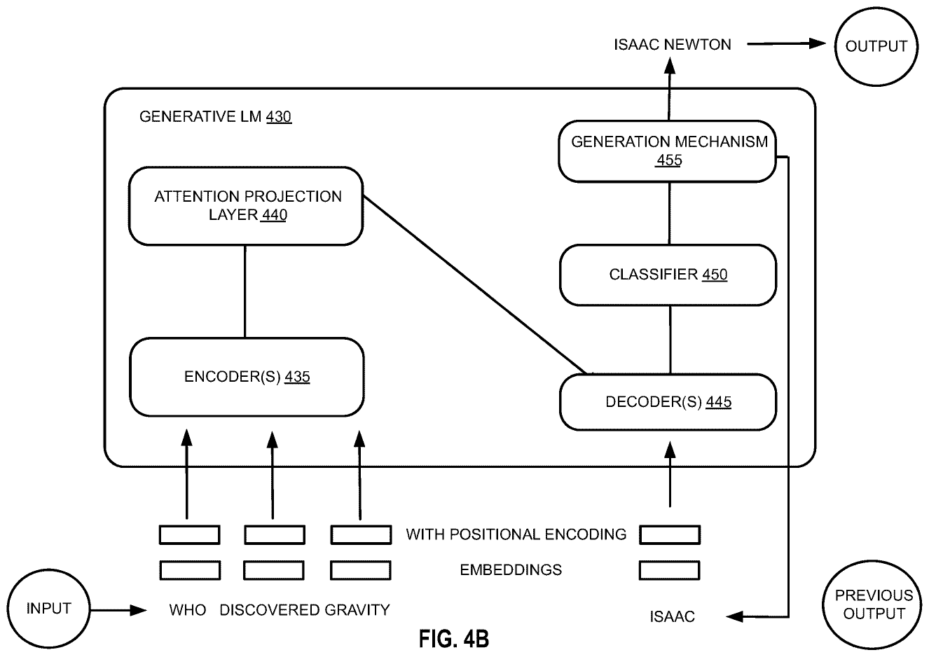

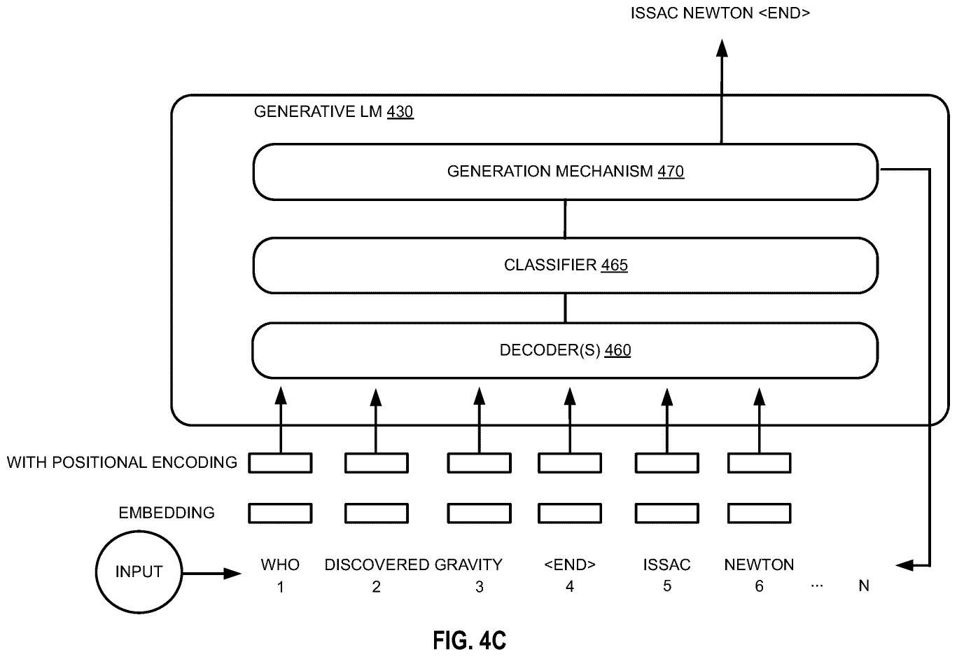

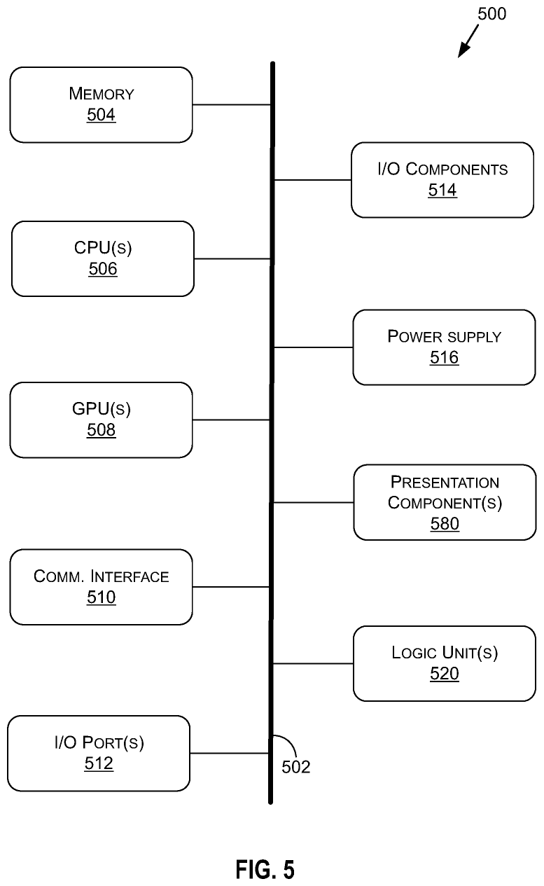

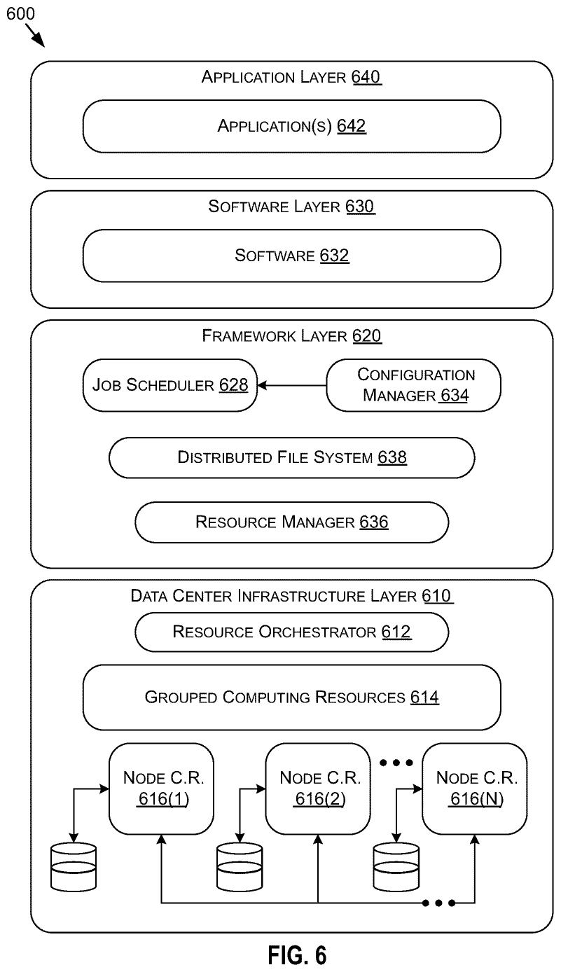

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 400 of FIG. 4A, example generative language model (LM) 430 of FIGS. 4B-4C, example computing device 500 of FIG. 5, and/or example data center 600 of FIG. 6.

The system 100 can implement at least a portion of retrieval pipeline, such as but not limited to a RAG pipeline, a hybrid retrieval pipeline, and/or a ranking-based retrieval pipeline. The system 100 can be used to process query-based retrieval and/or evaluate pipeline performance by any of various systems described herein, including but not limited to information retrieval systems, automated decision support systems, content recommendation systems, data analysis platforms, knowledge management systems, interactive query processing systems, and/or document processing systems.

Generally, the retrieval pipeline can include operations performed by the system 100. For example, the retrieval pipeline can include any one or more of a retrieval-embedding stage, a reranking stage, a generation stage, and/or an analysis stage. Each stage of the retrieval pipeline includes one or more components of the system 100 that perform the functions described herein. The system 100 can include a configuration dataset 102, an evaluation dataset 104, an embedding system 106, a retrieval system 108, a host system 110, model(s) 112, a reranking system 114, a response generation system 116, an analysis system 118, and metric(s) 120. The embedding system 106, reranking system 114, and/or response generation system 116 can be implemented as microservice computing systems. The system 100 can execute retrieval, ranking, response generation, and/or evaluation operations using structured pipeline configurations. In some implementations, one or more of the stages can be performed during the training of AI models. Additionally, one or more of the stages can be performed during the inference phase using the AI models. The system 100 can process retrieval, ranking, and response generation operations across multiple pipeline configurations, facilitating execution of structured modeling workflows. The system 100 can interface with evaluation tools (e.g., pipeline execution management systems, retrieval benchmarking frameworks, and/or structured monitoring tools) to manage pipeline execution, store evaluation metrics, and/or process retrieval-augmented generation workflows within an integrated computational environment.

The system 100 (e.g., implementing the retrieval pipeline) can obtain a configuration dataset and an evaluation dataset. For example, the configuration dataset can identify a pipeline and the evaluation dataset can include a set of content and at least one query. In some implementations, implementing the retrieval pipeline can include the system 100 generating (e.g., using a first artificial intelligence (AI) model of the pipeline) a plurality of embeddings of the set of content. Additionally, implementing the retrieval pipeline can include the system 100 retrieving (e.g., from a vector database) at least one candidate content from the plurality of embeddings based at least on a similarity metric between the at least one candidate content and the at least one query. In some implementations, implementing the retrieval pipeline can include the system 100 determining a performance metric based at least on the retrieved at least one candidate content. Additionally, implementing the retrieval pipeline can include the system 100 providing the performance metric.

In some implementations, implementing the retrieval pipeline can include the system 100 updating (e.g., using a second AI model) an order of the plurality of candidate content based at least on ranking the plurality of candidate content. For example, the candidate content can be ranked using at least one of (i) a vector similarity metric, (ii) query relevance metric, (iii) retrieval confidence metric, or (iv) aggregation metric. Additionally, implementing the retrieval pipeline can include the system 100 applying the at least one candidate content and the at least one query as input to a third AI model of the pipeline to cause the third AI model to generate an output. For example, generating the performance metric can be further based on the output and corresponding ground truth data.

In some implementations, the retrieval-embedding stage can be the stage in the retrieval pipeline in which the system 100 can generate content embeddings for candidate content using an embedding model (e.g., dense retriever, sparse retriever, transformer-based embedding model) selected based on the configuration dataset 102. The system 100 can include at least one embedding system 106. The embedding system 106 can obtain a configuration dataset (e.g., YAM L-based job configuration) and an evaluation dataset. That is, a job orchestration layer can process configuration parameters to determine execution logic for embedding generation, retrieval, and ranking. Additionally, the configuration dataset can identify a pipeline (e.g., select a RAG pipeline based on the YAML configuration) and the evaluation dataset (e.g., documents and queries including synthetic data, publicly available data, and/or customer-provided datasets) including a set of content (e.g., documents, records, files) and at least one query (e.g., structured search query, natural language question, and/or any context-dependent retrieval input).

In some implementations, the configuration dataset 102 can store structured configuration parameters (e.g., YAML-based pipeline templates, JSON configuration files, and/or any structured metadata configuration) defining pipeline execution, including retrieval model selection, ranking logic, response generation parameters, and/or evaluation criteria. For example, the configuration dataset 102 can identify at least one configuration template (e.g., predefined Haystack templates, such as how different models are used within the pipeline, defining model selection, retrieval methods, and/or ranking options) to implement the pipeline. In some implementations, the evaluation dataset 104 can store content records, queries, and/or corresponding ground truth data for retrieval evaluation (e.g., query-document pairs, labeled datasets, and/or synthetic evaluation data).

Additionally, the retrieval-embedding stage can be the stage in the retrieval pipeline in which the embedding system 106 can generate a plurality of embeddings (e.g., vector representations of the documents) of the set of content. That is, the embedding system 106 can use a first artificial intelligence (AI) model (e.g., retriever model (e.g., embedding-based retrieval model) selected from the configuration template) of the pipeline by transmitting an inference request to the host system 110 to execute the embedding model and receiving numerical vector representations corresponding to the content features. For example, the first AI model can be identified from the at least one configuration template (e.g., modular configuration structure, such as provide pipeline settings rather than require a manual coded model setup). The first AI model can be a model of the model(s) 112 stored in the host system 110. In some implementations, the retrieval system 108 can interface with the embedding system 106 and/or the host system 110 to facilitate embedding generation, retrieval processing, and query embedding transformation. That is, the model(s) 112 of the host system 110 can execute an embedding model (e.g., dense retriever, contrastive embedding model, or neural sparse retriever) based on received inference requests and return generated embeddings to the retrieval system 108. For example, the embedding system 106 can transmit content records from the evaluation dataset 104 to the retrieval system 108, which can request embedding inference execution from the host system 110 to obtain high-dimensional vector representations for indexing and retrieval processing.

The embedding system 106 can process content from the evaluation dataset 104 by transmitting an inference request to the retrieval system 108, which can transmit the request to the host system 110. The host system 110 can execute an embedding model from model(s) 112 (e.g., dense passage retrieval (DPR) model, contrastive learning model, and/or any vector-based encoding model) to generate embeddings. The retrieval system 108 can receive embeddings and store indexed embeddings in a vector database (e.g., Milvus, FAISS, and/or any similarity search database) for retrieval-based processing.

It should be understood that while the host system 110 and the model(s) 112 are described as separate components from the embedding system 106, the reranking system 114, and/or the response generation system 116, model execution can be performed locally within these components, with retrieval operations facilitated through the retrieval system 108. That is, the model(s) 112 can be deployed within the embedding system 106, the reranking system 114, and/or the response generation system 116, where each system can execute inference requests directly while maintaining interactions with the retrieval system 108 for retrieval queries, ranking adjustments, and/or candidate content selection. For example, the retrieval system 108 can transmit indexing requests and query embeddings to a locally executed embedding model within the embedding system 106, retrieve candidate content based on similarity computations, and/or transmit ranked results to a reranking model executing within the reranking system 114. In this example, the retrieval system 108 can manage retrieval execution workflows while interfacing with locally deployed models for embedding generation, retrieval, ranking, and/or response synthesis without requiring external inference requests to the host system 110.

In some implementations, the retrieval system 108 can obtain query embeddings from the embedding system 106 and execute retrieval operations based on similarity metrics (e.g., cosine similarity, approximate nearest neighbor (ANN) search, and/or BM25 scoring). The retrieval system 108 can transmit an inference request to the host system 110 to execute a retrieval model from model(s) 112 (e.g., sparse retriever, hybrid retriever, and/or lexical matching retriever). The host system 110 can execute the retrieval model and return retrieved candidate content to the retrieval system 108. That is, the retrieval system 108 and/or embedding system 106 can retrieve, from a vector database, at least one candidate content (e.g., top-K retrieved documents most similar to the query) from the plurality of embeddings based at least on a similarity metric (e.g., compare document embeddings to the query embeddings) between the at least one candidate content and the at least one query.

In some implementations, the retrieval system 108 can transmit retrieved candidate content to the embedding system 106 to perform retrieval-based query expansion by re-embedding retrieved documents and generating augmented query embeddings. For example, the embedding system 106 can apply a re-embedding operation on retrieved content to generate additional query-aligned embeddings that refine subsequent retrieval operations. In some implementations, the retrieval system 108 can transmit retrieved candidate content to the reranking system 114 for ranking adjustments. That is, the reranking system 114 can process retrieved candidate content using a ranking model (e.g., cross-encoder ranking model, boosting-based reranker, or neural ranking function) executed by the host system 110 to compute ranking scores and update retrieval ranking order.

In some implementations, the retrieval system 108 and/or embedding system 106 can store the plurality of embeddings in the vector database (e.g., Milvus temporary storage). That is, the retrieval system 108 can generate and store document embeddings in an indexed structure, facilitating similarity-based retrieval operations. Additionally, generating the plurality of embeddings can include generating a vector index (e.g., sharing documents and storing embeddings in an organized retrieval index) for the set of content. For example, the retrieval system 108 can maintain multiple versions of indexed embeddings corresponding to different embedding models, allowing retrieval operations to be dynamically configured based on selected retrieval pipelines. In some implementations, the retrieval system 108 and/or embedding system 106 can generate (e.g., encode the queries to perform semantic retrieval) a plurality of query embeddings representing the at least one query. That is, the query embeddings can be generated using the first AI model (e.g., by providing inference requests to the model(s) 112 via the retrieval system 108). The at least one candidate content can be retrieved based at least on the similarity metric determined (e.g., compare the query embeddings against the document embeddings in the vector database) between the plurality of query embeddings and the plurality of embeddings stored in the vector database.

In some implementations, the reranking stage can be the stage in the retrieval pipeline in which the system 100 can apply ranking functions to reorder retrieved candidate content based on ranking scores. The system 100 can include at least one reranking system 114. The reranking system 114 can update (e.g., perform reranking of the set of retrieved documents) an order of the plurality of candidate content based at least on ranking the plurality of candidate content. That is, the at least one candidate content can include a plurality of candidate content. The reranking can be performed using a second AI model of the model(s) 112 of the host system 110. In some implementations, the retrieval system 108 can interface with the reranking system 114 and/or the host system 110 to facilitate reranking execution and ranking score aggregation. That is, the model(s) 112 of the host system 110 can process ranking inference requests, compute ranking scores for retrieved content, and/or return ranking outputs to the reranking system 114. For example, the reranking system 114 can transmit candidate content to the retrieval system 108, which can forward a ranking model execution request to the host system 110, process ranking computations, and/or return updated ranked results. Additionally, the ranking can be performed using at least one of (i) a vector similarity metric (e.g., cosine similarity, dot product similarity, Euclidean distance), (ii) query relevance metric (e.g., TF-IDF, BM25), (iii) retrieval confidence metric (e.g., SoftMax, confidence value), and/or (iv) aggregation metric.

In some implementations, the reranking system 114 can process retrieved candidate content by transmitting an inference request to the retrieval system 108, which can forward the request to the host system 110 to execute a ranking model from model(s) 112 (e.g., cross-encoder ranking model, boosted decision tree-based ranking model, and/or deep neural ranking function). The host system 110 can execute the ranking model, return ranking scores, and transmit ranked candidate content to the retrieval system 108. In some implementations, the retrieval system 108 can transmit ranked candidate content to the reranking system 114 to apply additional ranking refinements based on auxiliary ranking features (e.g., metadata-based ranking, contextual ranking modifications, and/or user feedback signals). For example, the reranking system 114 can adjust ranking scores by incorporating document-specific metadata, such as content recency, citation frequency, and/or domain-specific relevance scoring. The retrieval system 108 can process ranked candidate content and transmit the results to the response generation system 116. That is, the response generation system 116 can receive ranked candidate content as input and perform response synthesis by applying a text generation model to produce a structured output.

In some implementations, the response generation stage can be the stage in the retrieval pipeline in which the system 100 can generate a response based on retrieved and ranked candidate content. The system 100 can include at least one response generation system 116. The response generation system 116 can apply (e.g., end-to-end RAG) the at least one candidate content and the at least one query as input to a third AI model of the pipeline to cause the third AI model to generate an output. The output generation can be performed using a third AI model of the model(s) 112 of the host system 110. In some implementations, the retrieval system 108 can interface with the response generation system 116 and/or the host system 110 to facilitate inference execution for response synthesis. That is, the model(s) 112 of the host system 110 can process response generation inference requests, apply a large language model (LLM), and return a generated response to the response generation system 116. For example, the response generation system 116 can apply prompt-based conditioning by structuring retrieved candidate content and query inputs into a formatted prompt before transmitting an inference request to the host system 110. The response generation system 116 can process the returned output, apply decoding and post-processing functions, and/or transmit the final response for evaluation (e.g., by the analysis system 118).

The response generation system 116 can transmit an inference request to the retrieval system 108, which can forward the request to the host system 110 to execute a response generation model from model(s) 112 (e.g., decoder-only LLM, retrieval-augmented generation (RAG) model, instruction-tuned LLM, and/or sequence-to-sequence transformer), generating a response based on ranked candidate content and an input query. The host system 110 can execute the response generation model, return generated responses, and/or transmit response outputs to the retrieval system 108. The retrieval system 108 can process response outputs and transmit the results to the analysis system 118.

In some implementations, the analysis stage can be the stage in the retrieval pipeline in which the system 100 can evaluate retrieval, ranking, and/or response generation effectiveness. The system 100 can include at least one analysis system 118. The analysis system 118 can determine one or more metric(s) 120 (e.g., performance metric) based at least on the retrieved at least one candidate content (e.g., using pytrec_eval, comparing to ground truth data from the evaluation dataset, and/or using ragas). For example, the metrics 120 can be recall@K, NDCG@K, context recall, context precision, mean reciprocal rank (MRR), semantic similarity, and/or any retrieval, ranking, and/or response evaluation metric. Additionally, generating the metrics 120 (e.g., performance metric) can be further based on the output (e.g., of the response generation system 116) and corresponding ground truth data.

The analysis system 118 can evaluate retrieval, ranking, and response generation by computing evaluation metrics based on retrieved content, ranked results, and/or generated responses. The analysis system 118 can compare retrieval outputs, ranking adjustments, and response outputs to reference ground truth data from the evaluation dataset 104. The analysis system 118 can determine performance metrics (e.g., recall at K (R@K), normalized discounted cumulative gain at K (NDCG@K), mean reciprocal rank (MRR), answer similarity, and/or response fluency) and store computed evaluation results. The metric(s) 120 can include retrieval accuracy, ranking effectiveness, response similarity, and/or any evaluation metric referenced in the configuration dataset 102. The analysis system 118 can return evaluation metrics (e.g., structured JSON reports, visual analytics dashboards, and/or comparative performance summaries) to the retrieval system 108 for retrieval scoring updates and to downstream systems for pipeline improvements and configuration updates.

In some implementations, the retrieval system 108 can generate, based on the configuration dataset 102, a plurality of pipeline configurations (e.g., generate different configurations of a RAG pipeline). That is, the retrieval system 108 can generate multiple variations of retrieval, ranking, and response generation workflows based on structured pipeline templates (e.g., YAM L-based configurations, J SON pipeline definitions, and/or dynamic pipeline instantiation frameworks). The retrieval system 108 can perform automated architecture testing. For example, at least one pipeline configuration of the plurality of pipeline configurations can include at least one of the first AI model, the second AI model, or the third AI model (e.g., the model(s) 112).

In some implementations, the retrieval system 108 can perform at least one pipeline modeling job corresponding to at least one of the plurality of pipeline configurations. That is, the retrieval system 108 can execute retrieval, ranking, and/or response generation operations under different pipeline configurations to compare performance variations across models and scoring functions. The retrieval system 108 can perform retrieval, reranking, and/or answer generation in parallel (e.g., grid search-style exploration, where different YAM L configurations can be tested across various retrievers, rerankers, and/or LLMs).

In some implementations, the analysis system 118 can determine the performance metric (e.g., the metrics 120) corresponding to the retrieved at least one candidate content or the output generated by the third AI model (e.g., measure both retrieval performance (e.g., recall) and final answer quality (e.g., semantic similarity to ground truth)). That is, the analysis system 118 can compute evaluation scores (e.g., retrieval effectiveness, ranking consistency, and/or response coherence) based on pipeline execution logs and reference ground truth data from the evaluation dataset 104. The metric(s) 120 can be determined for the at least one pipeline modeling job.

In some implementations, the retrieval system 108 can update at least one of the plurality of pipeline configurations (e.g., change retriever model from dense to sparse retriever) based at least on the performance metric across the plurality of pipeline configurations. That is, the retrieval system 108 can modify retrieval, ranking, and/or response generation models based on performance analysis results, selecting configurations that improve retrieval accuracy, ranking precision, and/or response relevance. Updating can include selecting, modifying, updating, and/or replacing pipeline components (e.g., retriever, reranker, LLM). For example, TAM L configuration files can be updated such that retrieval scoring functions, ranking model weights, and/or prompt engineering parameters are adjusted based on performance results. For example, if the reranker does not improve performance, the reranker can be removed from the pipeline. In this example, the retrieval system 108 can update retrieval parameters to compensate for ranking adjustments and optimize retrieval ranking thresholds accordingly.

The retrieval system 108 can receive, from a user device, a status request corresponding to a pipeline modeling job. That is, the retrieval system 108 can process status queries related to retrieval, ranking, and/or response generation execution based on configurations defined in the configuration dataset 102. The retrieval system 108 can determine a status of the pipeline modeling job by referencing execution logs, querying active model inference tasks, and/or retrieving evaluation progress data from the analysis system 118. The retrieval system 108 can transmit a request to the host system 110 to retrieve execution status updates for the model(s) 112 currently performing inference operations. The retrieval system 108 can provide, to the user device, the status in a structured format (e.g., JSON, YAML, and/or any structured response format). For example, the retrieval system 108 can return the status/result of a job to the user, including pipeline execution progress, retrieval scoring results, ranking model execution logs, and/or response generation evaluation metrics.

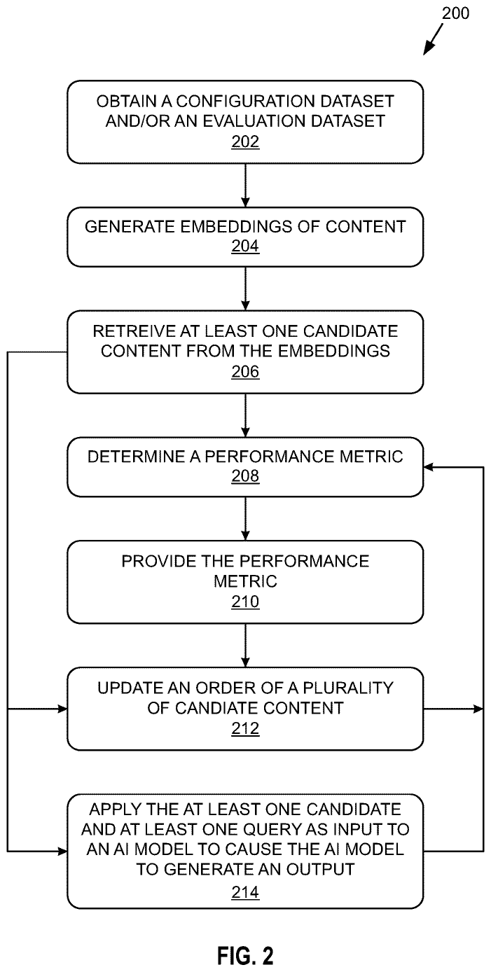

With reference to FIG. 2, an example of a method for pipeline configuration and modular processing for retrieval-augmented generation in a retrieval pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 4A-4C), one or more computing devices or components thereof (e.g., as described in FIG. 5), and/or one or more data centers or components thereof (e.g., as described in FIG. 6).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for obtaining, generating, retrieving, determining, providing, updating, and/or applying operations (among other operations), in accordance with some implementations of the present disclosure. Various operations of method 200 can relate to improving retrieval, ranking, and/or response generation by structuring pipeline execution through configuration-based orchestration. Existing systems often rely on and/or use static retrieval architectures that lack dynamic model selection, which can lead to suboptimal and/or reduced retrieval accuracy when processing new datasets. The existing technological problems can arise when these systems require manual reconfiguration of indexing, retrieval, and/or ranking components, resulting in increased latency and resource inefficiencies. Method 200 of FIG. 2 can solve these technological problems by implementing structured retrieval configurations (e.g., configuration datasets) that can define model selection, retrieval scoring functions, ranking adjustments, and/or generation logic without requiring manual pipeline modifications, thereby improving retrieval precision, retrieval model execution efficiency, and ranking accuracy across different datasets.

The method 200, at block 202, includes obtaining a configuration dataset and an evaluation dataset. For example, the configuration dataset can identify a pipeline and the evaluation dataset can include a set of content and at least one query. For example, the processing circuits and/or processing circuitry can implement a job orchestration layer using a YAML-based job configuration of the configuration dataset. The pipeline can be a selected RAG pipeline based on the YAML configuration. The evaluation dataset can include documents and queries including synthetic data, publicly available data, and/or customer-provided datasets. Additionally, the set of content can be documents, records, and/or files. In some implementations, the configuration dataset can identify at least one configuration template (e.g., predefined Haystack templates, such as how different models are used within the pipeline-defining model selection, retrieval methods, and ranking options) to implement the pipeline.

The method 200, at block 204, includes generating, using a first artificial intelligence (AI) model of the pipeline, a plurality of embeddings of the set of content. The first AI model can be a retriever model, such as an embedding-based retrieval model. The embeddings can be vector representations of the documents. Additionally, the first AI model can be identified from the at least one configuration template (e.g., modular configuration structure, such as provide pipeline settings rather than require a manual coded model setup). In some implementations, the processing circuits can store the plurality of embeddings in the vector database (e.g., Milvus temporary storage). In some implementations, generating the plurality of embeddings can include generating a vector index (e.g., sharing documents and storing embedding in an organized retrieval index) for the set of content.

The method 200, at block 206, includes retrieving, from a vector database, at least one candidate content from the plurality of embeddings based at least on a similarity metric between the at least one candidate content and the at least one query. For example, the candidate content can be top-K retrieved documents that are most similar to the query. In this example, the similarity metric can be used to compare document embeddings to the query embeddings. In some implementations, the processing circuits can generate (e.g., encode the queries to perform semantic retrieval), using the first AI model, a plurality of query embeddings representing the at least one query. That is, the at least one candidate content can be retrieved based at least on the similarity metric determined (e.g., compare the query embeddings against the document embeddings in the vector database) between the plurality of query embeddings and the plurality of embeddings stored in the vector database.

The method 200, at block 208, includes determining a performance metric based at least on the retrieved at least one candidate content (e.g., comparing to ground truth data from the evaluation dataset). For example, the performance metrics can be recall@ K, NDCG@K, context recall, and/or context precision. Additionally, a performance metric can be determined responsive to reranking (at block 212) and generating an output during inference (at block 214). That is, generating the performance metric in block can be further based on the output (at block 214) and corresponding ground truth data. For example, the processing circuits can compute evaluation metrics using an analysis system (e.g., analysis system 118) to compare retrieved candidate content and response generation outputs against reference answers stored in the evaluation dataset. The processing circuits can apply retrieval effectiveness scoring (e.g., recall@K), ranking evaluation functions (e.g., NDCG@K), and semantic similarity analysis (e.g., comparing generated responses to reference responses) to determine overall pipeline performance.

The method 200, at block 210, includes providing the performance metric. That is, the processing circuits can transmit computed performance metrics to a user device, pipeline management system, and/or structured data repository for further analysis. For example, the processing circuits can generate structured evaluation results (e.g., JSON format) that specify retrieval performance, ranking accuracy, and/or response generation quality. The processing circuits can provide the performance metric to a monitoring interface, facilitating pipeline reconfiguration based on evaluation results.

The method 200, at block 212, includes updating (e.g., perform reranking of the set of retrieved documents), using a second AI model, an order of the plurality of candidate content based at least on ranking the plurality of candidate content. The at least one candidate content can include a plurality of candidate content. That is, the ranking can be performed using at least one of (i) a vector similarity metric (e.g., e.g., cosine similarity, dot product similarity, Euclidean distance), (ii) query relevance metric (e.g., TF-IDF, BM25), (iii) retrieval confidence metric (e.g., SoftMax, confidence value), or (iv) aggregation metric.

The method 200, at block 214, includes applying (e.g., end-to-end RAG) the at least one candidate content and the at least one query as input to a third AI model of the pipeline to cause the third AI model to generate an output. That is, the third AI model can be a language model (e.g., LLM and/or any transformer-based model). For example, applying can include formatting the retrieved candidate content and the input query into a structured prompt before transmitting an inference request to a system to execute the third AI model. In this example, the response generation system (e.g., response generation system 116) can concatenate the retrieved candidate content with the query, apply tokenization, and/or submit the processed input to the model(s) for response generation.

In some implementations, method 200 can include generating (e.g., perform automated architecture testing), based on the configuration dataset, a plurality of pipeline configurations (e.g., generate different configurations of a RAG pipeline). That is, at least one pipeline configuration of the plurality of pipeline configurations can include at least one of the first AI model, the second AI model, or the third AI model. In some implementations, method 200 can include performing at least one pipeline modeling job (e.g., performing retrieval, reranking, and/or answer generation in parallel (e.g., grid search-style exploration, where different YAML configurations are tested across various retrievers, rerankers, and LLMs) corresponding to at least one of the plurality of pipeline configurations.

In some implementations, method 200 can include determining, for the at least one pipeline modeling job, the performance metric corresponding to the retrieved at least one candidate content or the output generated by the third AI model (e.g., measure both retrieval performance (e.g., recall) and final answer quality (e.g., semantic similarity to ground truth)). In some implementations, method 200 can include updating (e.g., select, modify, or replace pipeline components (e.g., retriever, reranker, LLM)) at least one of the plurality of pipeline configurations (e.g., change retriever model from dense to sparse retriever) based at least on the performance metric across the plurality of pipeline configurations. For example, if the reranker does not improve performance, the reranker can be removed from the pipeline. In some implementations, method 200 can include receiving, from a user device, a status request corresponding to a pipeline modeling job. The processing circuits can determine a status of the pipeline modeling job and provide, to the user device, the status (e.g., return the status/result of a job to the user (e.g., as JSON).

The systems and methods described herein can be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations can be comprised in a variety of different systems such as automotive systems (e.g., a control system for an autonomous or semi-autonomous machine, a perception system for an autonomous or semi-autonomous machine), systems implemented using a robot or robotic platform, aerial systems, medical systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (V M s), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

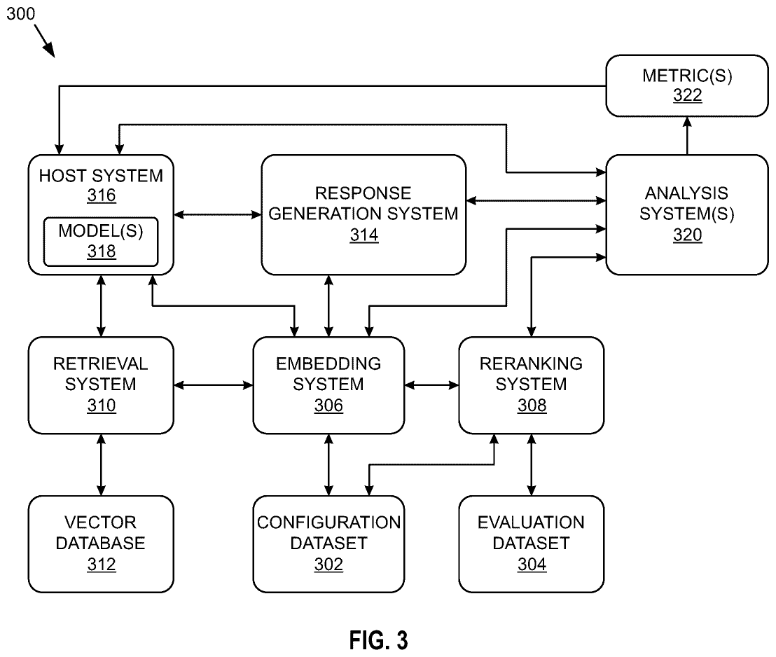

Referring now to FIG. 3, a block diagram of an example of the retrieval pipeline, in accordance with some implementations of the present disclosure. Generally, system 300 includes modular components that can facilitate retrieval-augmented generation (RA G) pipeline execution, evaluation, and/or optimization. The configuration dataset 302 can define pipeline structures, including retrieval models, ranking models, and/or response generation models and the evaluation dataset 304 can include structured and unstructured content, query data, and/or ground truth information for benchmarking performance. The host system 316 can execute model(s) 318 in response to inference requests received from various pipeline components, such as the embedding system 306, the retrieval system 310, the reranking system 308, and/or the response generation system 314.

It should be understood that while the host system 316 and the model(s) 318 are described as separate components from the embedding system 306, the retrieval system 310, the reranking system 308, and/or the response generation system 314, model execution can be performed locally within these components, with retrieval operations facilitated through the retrieval system 310. The embedding system 306, reranking system 308, and/or response generation system 314 can be implemented as microservice computing systems. That is, the model(s) 318 can be deployed within the embedding system 306, the reranking system 308, and/or the response generation system 314, where each system can execute inference requests directly while maintaining interactions with the retrieval system 310 for retrieval queries, ranking adjustments, and candidate content selection. For example, the retrieval system 310 can transmit indexing requests and query embeddings to a locally executed embedding model within the embedding system 306, retrieve candidate content based on similarity computations, and/or transmit ranked results to a reranking model executing within the reranking system 308. In this example, the retrieval system 310 can manage retrieval execution workflows while interfacing with locally deployed models for embedding generation, retrieval, ranking, and/or response synthesis without requiring external inference requests to the host system 316.

It should also be understood that the components of system 300 in FIG. 3 correspond to components of system 100 in FIG. 1, with different callouts used to describe functionally equivalent systems. For example, the embedding system 306 of FIG. 3 corresponds to the embedding system 106 of FIG. 1, the retrieval system 310 corresponds to the retrieval system 108, the reranking system 308 corresponds to the reranking system 114, and the response generation system 314 corresponds to the response generation system 116. Additionally, the host system 316 and model(s) 318 in FIG. 3 function in a similar capacity to the host system 110 and model(s) 112 in FIG. 1, processing inference requests and executing model-based operations for retrieval, ranking, and response generation. While different figure references are used, these components perform equivalent functions in facilitating retrieval-augmented generation (RAG) pipeline execution, evaluation, and/or optimization.

The system 300 can implement retrieval-augmented generation (RAG) configurations where retrieval and generation can operate independently. The retrieval system 310 can perform retrieval models (e.g., Haystack, LlamaIndex, LangChain) based on structured configuration templates. The retrieval system 310 can transmit inference requests to the host system 316, executing retrieval functions based on indexed content stored in the vector database 312. The retrieval system 310 can process retrieval execution parameters stored in the configuration dataset 302. The retrieval system 310 can perform retrieval functions based on predefined retrieval templates (e.g., dense retrieval, sparse retrieval, hybrid retrieval).

In some implementations, the retrieval system 310 can support and/or otherwise facilitate structured orchestration of retrieval models and facilitates modular evaluation of indexing and retrieval effectiveness. That is, retrieval processes can be implemented using structured pipeline definitions, allowing independent evaluation of different retriever models (e.g., dense retrieval models, sparse retrieval models, hybrid retrievers) and/or retrieval strategies. The retrieval system 310 can update retrieval logic based on retrieval performance metrics, such as recall at K (R@K), mean reciprocal rank (MRR), and/or normalized discounted cumulative gain (NDCG@K). By using template-based orchestration (e.g., YAML-based configuration), the retrieval pipeline can be structured without modifying monolithic codebases. Additionally, retrieval processes can be performed asynchronously, allowing parallel indexing and/or querying of vectorized content stored in the vector database 312.

The embedding system 306 can generate vector representations of content records in the evaluation dataset 304 and store the generated embeddings in the vector database 312 for retrieval-based processing. That is, the embedding system 306 can execute an inference request via the retrieval system 310, specifying an embedding model from the model(s) 318 hosted by the host system 316. The returned embeddings can be indexed and referenced in retrieval queries. The embedding system 306 can perform adaptive embedding selection, allowing for model variation testing. For example, embeddings generated using different embedding architectures can be evaluated for retrieval effectiveness. Additionally, structured indexing configurations can specify how embeddings can be stored, facilitating indexing parameters to be modified dynamically based on the evaluation dataset 304 properties.

The reranking system 308 can process retrieved candidate content by applying ranking models to reorder candidate content based on ranking functions referenced in the configuration dataset 302. That is, reranking operations can be structured to apply vector similarity-based ranking, query-document relevance ranking, retrieval confidence ranking, and/or aggregation-based ranking strategies. The reranking system 308 can interface with the retrieval system 310 to apply ranking logic on retrieved candidate content, executing ranking models from model(s) 318 via inference requests transmitted to the host system 316. Additionally, ranking evaluation metrics can be computed by the analysis system 320. For example, the analysis system 320 can facilitate ranking model updates (e.g., ranking function selection, ranking weight adjustments, and/or ranking model replacement, such as updating pairwise ranking models, updating cross-encoder ranking thresholds, updating aggregation-based ranking parameters, and/or any ranking model optimization process based on evaluation dataset characteristics) based on ranking effectiveness scores.

The response generation system 314 can apply retrieved and ranked candidate content as input to an LLM executed via the host system 316, generating a structured response. The response generation model can be a transformer-based LLM, such as a retrieval-augmented generation (RAG) model, decoder-only transformer, or instruction-tuned LLM. The generated response can be include retrieved knowledge in generated text. The response generation system 314 can reference structured response templates to format retrieval-integrated responses. Additionally, response evaluation metrics, such as semantic similarity, context fluency, and response coherence, can be computed by the analysis system 320, providing refinement of response generation logic.

The analysis system 320 can determine retrieval, ranking, and/or response generation performance metrics by comparing retrieved and generated outputs against ground truth data stored in the evaluation dataset 304. That is, evaluation metrics can be structured to analyze retrieval effectiveness, ranking accuracy, and/or generated response correctness. The analysis system 320 can interface with the retrieval system 310 to assess retrieval precision, with the reranking system 308 to evaluate ranking confidence, and/or with the response generation system 314 to compute generated answer accuracy. The analysis system 320 can store evaluation metrics in a structured repository. The pipeline components can reference evaluation results for model selection updates and hyperparameter tuning.

In some implementations, the vector database 312 can be implemented as a temporary repository for indexed embeddings, retrieved candidate content, and/or ranking-updated document representations. That is, the vector database 312 can manage and/or otherwise store multiple versions of indexed embeddings (e.g., to facilitate comparative retrieval analysis for different embedding configurations). The retrieval system 310 can query the vector database 312 to retrieve candidate content and/or apply retrieval scoring functions based on indexed embedding representations. Additionally, the vector database 312 can store query embeddings. For example, the queried embeddings can be used to perform query-document similarity calculations across different retrieval pipelines.

The system 300 can execute multiple pipeline modeling jobs, allowing parallel and asynchronous retrieval, ranking, and/or response generation evaluations. That is, different pipeline configurations can be assessed, where retrieval models, ranking models, and/or response generation models can be evaluated across multiple structured configurations. The retrieval system 310 can execute retriever benchmarking, the reranking system 308 can compare ranking function effectiveness, and/or the response generation system 314 can analyze generated response quality. The analysis system 320 can determine pipeline-wide performance scores. In some implementations, the analysis system 320 can determine pipeline-wide performance scores. The scores can be used to perform updating of the various pipeline execution parameters (e.g., retrieval, ranking, and/or response generation configurations, such as retrieval model selection, ranking function updates, inference execution parameters, and/or any pipeline configuration update based on performance evaluation).

The host system 316 can model execution for retrieval, ranking, embedding, training, and/or response generation components. That is, inference requests can be processed dynamically by selecting model(s) 318 corresponding to retrieval-based processing pipelines. The host system 316 can receive and process structured execution requests transmitted from the retrieval system 310, embedding system 306, reranking system 308, and/or response generation system 314. Additionally, pipeline configurations referenced in the configuration dataset 302 can specify execution dependencies, allowing retrieval, ranking, and generation models to be structured, for example, without requiring static code modifications.

In some implementations, the retrieval system 310 can facilitate adaptive retrieval execution, where retrieval models and retrieval strategies can be dynamically implemented based on retrieval evaluation metrics. That is, retrieval scoring functions can be updated based on retrieval model effectiveness scores stored by the analysis system 320. The retrieval system 310 can perform retrieval inference requests referencing retriever configurations stored in the configuration dataset 302. Additionally, retrieval indexing functions can be structured to support parallel and/or asynchronous processing.

The system 300 can perform adaptive pipeline evaluation, where retrieval, ranking, and/or response generation operations can be dynamically assessed across multiple structured configurations. That is, evaluation datasets can be processed through different retrieval, ranking, and/or generation models, facilitating structured benchmarking across pipeline variations. The retrieval system 310 can evaluate retrieval effectiveness, the reranking system 308 can determine ranking stability, and/or the response generation system 314 can assess semantic alignment between generated responses and ground truth content. The analysis system 320 can generate performance reports. For example, the reports can be used to update the structured pipeline based on retrieval precision, ranking consistency, and/or response coherence scores.

In some implementations, the system 300 can improve retrieval-augmented generation pipeline adaptability by supporting dynamic retrieval, ranking, and/or response generation evaluations. That is, retrieval configurations can be updated based on retrieval performance scores, ranking models can be updated based on ranking evaluation feedback, and/or response generation pipelines can be updated based on response synthesis metrics. The host system 316 can execute structured model selection, facilitating retrieval, ranking, and/or response generation components to be structured dynamically based on pipeline optimization and/or improvement objectives. The vector database 312 can provide content retrieval (e.g., updating indexing and retrieval logic based on dataset-specific configurations).

The system 300 can receive, from at least one dataset, a configuration dataset 302 and an evaluation dataset 304. The configuration dataset 302 can define a pipeline (e.g., embedding system 306, reranking system 308, retrieval system 310, response generation system 314, and/or any model execution environment associated with the model(s) 318) and execution parameters for retrieval, ranking, and/or response generation. The evaluation dataset 304 can include a set of content records, at least one query, and/or corresponding ground truth data. The host system 316 can receive pipeline execution requests referencing configuration parameters stored in the configuration dataset 302 to execute the model(s) 318 for embedding generation, retrieval, ranking, and/or response generation. The embedding system 306 can generate embeddings for content records in the evaluation dataset 304, the retrieval system 310 can identify candidate content using retrieval models executed by the host system 316, and the reranking system 308 can updating ranking order based on ranking functions applied by the model(s) 318. The response generation system 314 can transmit an inference request to the host system 316 to execute a response generation model (e.g., LLM) and process ranked content to generate a response corresponding to at least one input query.

Generally, the system 300 can obtain a configuration dataset 302 and an evaluation dataset 304 to define and execute retrieval-augmented generation (RAG) pipelines. The configuration dataset 302 can specify pipeline execution parameters, including embedding generation, retrieval, reranking, and/or response generation. The evaluation dataset 304 can provide content records, queries, and ground truth data for model assessment. The host system 316 can receive configuration parameters and initiate pipeline execution by invoking models from model(s) 318 to process embeddings, retrieve candidate content, rank retrieved results, and/or generate response outputs. That is, the embedding system 306 can generate embeddings for the content records within the evaluation dataset 304, the retrieval system 310 can retrieve candidate content based on similarity computations, and/or the reranking system 308 can reorder retrieved content based on ranking criteria executed by the model(s) 318. The response generation system 314 can process ranked content by invoking inference execution on the host system 316 to generate a structured output corresponding to an input query.

The embedding system 306 can transmit an inference request to the retrieval system 310 to execute at least one embedding model (e.g., dense retriever, sparse retriever, contrastive learning model, and/or any embedding model executed within model(s) 318) via the host system 316 to generate a plurality of embeddings of the content records in the evaluation dataset 304. The embedding system 306 can provide content records as input to the retrieval system 310, which transmits the embedding inference request to the host system 316. The host system 316 can execute an embedding model, generate high-dimensional vector representations corresponding to content features, and/or return the embeddings to the retrieval system 310. The retrieval system 310 can store indexed representations in the vector database 312, facilitating retrieval operations. That is, the retrieval system 310 functions as an interface between the embedding system 306, the host system 316, and/or the vector database 312, facilitating storage and retrieval pipelines.

The embedding system 306 can execute an embedding model (e.g., dense retriever, sparse retriever, or contrastive learning model) from model(s) 318 to generate numerical representations of content within the evaluation dataset 304. The retrieval system 310 can manage embedding storage and retrieval by interfacing with the vector database 312 to store and/or query content embeddings. That is, the retrieval system 310 can transmit an inference request to the host system 316, specifying an embedding model execution request. The host system 316 can process the request, generate embeddings, and/or return computed representations to the retrieval system 310, which can store the embeddings in an indexed format. The retrieval system 310 can later reference indexed embeddings when processing retrieval queries, executing retrieval models using similarity-based retrieval scoring functions stored in the configuration dataset 302.

In some implementations, the embedding system 306 can initiate an evaluation request through the retrieval system 310, which can transmit an inference request to and/or otherwise interface with the host system 316 specifying an embedding model and/or benchmarking parameters. That is, the retrieval system 310 can interact with the analysis system 320 to execute an evaluation pipeline by integrating embedding generation, indexing, and/or retrieval. The analysis system 320 can invoke an evaluation tool to construct a retrieval pipeline (e.g., dense retriever) incorporating the embedding model. The embedding system 306 can provide content records to the retrieval system 310. For example, the retrieval system 310 can index the documents from the evaluation dataset 304 and apply retrieval queries for performance assessment. The analysis system 320 can process retrieval effectiveness metrics (e.g., recall at K (R@K), normalized discounted cumulative gain at K (NDCG@K)) based on retrieved results, mean reciprocal rank (MRR), precision at K (P@K), and/or any other performance metric associated with retrieval ranking quality, query-document relevance, and/or retrieval latency.

The analysis system 320 can store evaluation details in a structured repository and update retrieval scoring parameters. That is, retrieval performance results can be logged for further analysis. The retrieval system 310 can transmit a request to the host system 316 to retrieve evaluation results. For example, the host system 316 can query the analysis system 320 for stored evaluation details. The analysis system 320 can return evaluation metrics in a structured format (e.g., JSON) to the retrieval system 310, which can process the results for embedding system 306 operations. Additionally, the analysis system 320 can generate reports based on retrieval effectiveness, embedding model variations, and/or dataset-specific retrieval configurations. In some implementations, the retrieval system 310 can update retrieval scoring parameters using evaluation feedback, updating similarity thresholds for subsequent retrieval operations.

The retrieval system 310 can interface with the embedding system 306 by processing embedding requests and/or facilitating indexed content representations within the vector database 312. That is, the embedding system 306 transmits embedding requests through the retrieval system 310, which can forward inference calls to the host system 316 (e.g., to the model(s) 318). The retrieval system 310 processes returned embeddings, manages storage operations, and/or performs retrieval queries based on stored embeddings. The retrieval system 310 can apply retrieval constraints based on embedding variations, updating retrieval models based on indexing parameters. In some implementations, the retrieval system 310 can improve query-to-embedding alignment by updating retrieval configurations in response to retrieval effectiveness metrics stored by the analysis system 320.

In some implementations, the retrieval system 310 can process retrieval configurations based on structured YAML-based pipeline definitions. The retrieval system 310 can reference retrieval parameters (e.g., retriever model selection, reranker model selection, retrieval indexing strategy) to execute retrieval functions. The retrieval system 310 can apply retrieval logic based on structured retrieval definitions, updating retrieval execution based on query distribution. The retrieval system 310 can update retrieval configurations based on retrieval execution results, updating retrieval scoring functions based on query-document similarity distributions.

Additionally, the retrieval system 310 can reference structured retrieval configurations for retriever execution. If the retrieval system 310 processes a pipeline without reranking, retrieval execution can be performed based on embedding-based similarity scoring. If a reranker is present, the retrieval system 310 can perform retrieval operations before transmitting candidate content to the reranking system 308 for ranking updates. The retrieval system 310 can dynamically determine retrieval execution logic based on retriever model definitions stored in the configuration dataset 302.

The retrieval system 310 can update retrieval execution logic based on evaluation dataset attributes stored in the evaluation dataset 304. The retrieval system 310 can reference retrieval indexing configurations (e.g., dense retrieval indexing, sparse retrieval indexing, hybrid retrieval indexing) to structure retrieval operations. The retrieval system 310 can process retrieval indexing functions asynchronously, indexing document embeddings while executing retrieval queries. The retrieval system 310 can update retrieval indexing strategies based on retrieval query complexity. The retrieval system 310 can update retrieval depth parameters based on query-document similarity distributions.

In some implementations, the retrieval system 310 can process retrieval inference requests for retrieval execution, updating retrieval logic based on retriever execution results. The retrieval system 310 can reference retrieval indexing structures for content retrieval, updating retrieval scoring functions based on stored retrieval evaluation results. The retrieval system 310 can process retrieval execution logic based on structured retrieval indexing functions (e.g., retrieval model selection and/or indexing pipeline configurations, such as vector indexing strategies, retrieval model weighting updates, retrieval cutoff parameters, and/or any retrieval execution logic updates based on retrieval effectiveness). The retrieval system 310 can update retrieval configurations based on retrieval execution results (e.g., retrieval effectiveness scores, query-document ranking comparisons, retrieval latency metrics), referencing stored retrieval indexing definitions to update retrieval execution logic.

The retrieval system 310 can execute retrieval models applied to stored embeddings and/or transmit a retrieval model execution request to the host system 316 to obtain candidate content from the vector database 312. That is, the retrieval system 310 can receive query embeddings from the embedding system 306, compare query embeddings against stored document embeddings, and/or retrieve the most relevant content based on similarity metrics (e.g., cosine similarity, approximate nearest neighbor (ANN) search, or BM25 ranking). The retrieval system 310 can update retrieval execution by updating retrieval parameters stored in the configuration dataset 302, improving retrieval depth, similarity thresholds, and/or ranking methods based on dataset attributes. The retrieval system 310 can facilitate retrieval operations dynamically, integrating embedding-based search with lexical retrieval techniques, updating retrieval logic based on query complexity.

The reranking system 308 can transmit an inference request to the retrieval system 310, which can forward a ranking model execution request to the host system 316 to assign ranking scores to candidate content retrieved from the vector database 312. That is, the reranking system 308 can specify ranking model parameters and provide ranking execution requests via the retrieval system 310 (e.g., communicating with the host system 316 to process the request). The host system 316 can execute the ranking model (e.g., cross-encoder ranking model, neural ranking function, boosting-based reranker, and/or any ranking model executed by model(s) 318) and return ranking scores for retrieved candidate content. The retrieval system 310 can transmit ranked candidate content to the reranking system 308, which can process ranking updates before sending content to the response generation system 314.

The reranking system 308 can apply a ranking model to update the order of retrieved candidate content before transmission to the response generation system 314. That is, the reranking system 308 can transmit an inference request to the retrieval system 310, which can interface with the host system 316 to execute a ranking model from model(s) 318. The reranking system 308 can specify ranking criteria (e.g., vector similarity metric, query relevance metric, retrieval confidence metric, or aggregation metric) to reorder retrieved content. The host system 316 can process the ranking model execution request, apply a ranking model (e.g., cross-encoder ranking model, boosting-based reranker, and/or neural ranking function), and return reordered results to the retrieval system 310. The retrieval system 310 can transmit the ranked candidate content to the reranking system 308, which can further refine ranking updates based on dataset attributes and stored ranking configurations.

In some implementations, the reranking system 308 can initiate an evaluation request by transmitting an inference call through the retrieval system 310, which can interface with the host system 316 to specify an embedding model, a reranking model, and/or a response generation model. That is, the retrieval system 310 can interface with the analysis system 320 to perform an evaluation pipeline by requesting a ranking evaluation process. The analysis system 320 can invoke an evaluation tool to construct an evaluation pipeline that integrates the embedding system 306, the reranking system 308, and/or the response generation system 314. The evaluation tool can retrieve dataset content via the retrieval system 310, perform retrieval-based ranking operations, and determine ranking effectiveness across stored content embeddings. The retrieval system 310 can provide ranked candidate content from retrieval operations as input to the evaluation pipeline. For example, the ranking models can process query-content similarity and generate ranked outputs.

The analysis system 320 can generate ranking evaluation metrics (e.g., recall at K (R@K), normalized discounted cumulative gain (NDCG@K), context recall, and/or answer similarity) and store computed evaluation results in a structured repository. That is, ranking accuracy and ranking performance metrics can be logged based on the execution of ranking models. The retrieval system 310 can transmit an evaluation status request to the host system 316, which can query the analysis system 320 for stored ranking evaluation details. The analysis system 320 can return structured evaluation results (e.g., JSON) corresponding to ranking effectiveness, retrieval precision, and/or response quality. Additionally, the analysis system 320 can compare ranking results across multiple evaluation configurations to determine ranking performance variations. In some implementations, the reranking system 308 can apply ranking evaluation feedback from the analysis system 320 to update ranking model parameters and update ranking strategies based on evaluation dataset 304 properties.

The retrieval system 310 can interface with the reranking system 308 by processing ranking requests and facilitating ranked content delivery. That is, the reranking system 308 transmits ranking requests through the retrieval system 310, which can forward inference calls to the host system 316. The retrieval system 310 can process returned ranking scores, apply ranking updates based on stored metadata, and/or transmit ranked results to downstream systems. The retrieval system 310 can apply ranking model constraints based on dataset attributes, updating ranking configurations based on retrieval performance metrics stored by the analysis system 320. In some implementations, the retrieval system 310 can update ranking execution logic based on ranking effectiveness feedback, improving ranking models for different content retrieval conditions.

The retrieval system 310 can transmit an inference request to the host system 316 to execute a retrieval model from model(s) 318 to obtain candidate content from the vector database 312 based on a similarity metric (e.g., approximate nearest neighbor (ANN) search, cosine similarity scoring, BM25 ranking, and/or any retrieval metric). The retrieval system 310 can receive query embeddings from the embedding system 306 and provide a retrieval model execution request to the host system 316. The host system 316 can process the retrieval request, execute a retrieval model, and/or return retrieved candidate content to the retrieval system 310. The retrieval system 310 can facilitate indexing and retrieval pipelines using configuration templates (e.g., YAML-based configurations) specifying retrieval logic, embedding models, and/or ranking functions. The retrieval system 310 can reference predefined retrieval pipelines stored in the configuration dataset 302, facilitating retrieval execution based on various indexing strategies and/or techniques. The retrieval system 310 can process retrieved candidate content and transmit the retrieval outputs to the reranking system 308 for ranking updates.

The vector database 312 can store embeddings generated by the embedding system 306 and retrieved candidate content identified by the retrieval system 310. The retrieval system 310 can query stored embeddings to perform similarity-based retrieval before transmitting an inference request to the host system 316 for executing a retrieval model. The vector database 312 can store indexed embeddings corresponding to different evaluation datasets, providing retrieval operations across various retrieval configurations. The retrieval system 310 can execute retrieval models applied to stored embeddings and reference retrieval configurations defined in the configuration dataset 302. The vector database 312 can maintain a plurality of indexed representations, providing comparative retrieval analysis based on different retrieval model executions. The retrieval system 310 can update retrieval parameters (e.g., retrieval scoring thresholds, similarity function selection, candidate retrieval depth, retrieval cutoff strategies, and/or any retrieval model-specific hyperparameter) based on retrieval model performance metrics, updating retrieval scoring thresholds, retrieval functions, and/or ranking updates in response to performance evaluations.

The retrieval system 310 can interface with the embedding system 306 and the reranking system 308 to process retrieval operations based on query embeddings. The embedding system 306 can transmit an inference request to the host system 316 to generate query embeddings, which the retrieval system 310 can reference for retrieval computations. The retrieval system 310 can facilitate retrieval pipeline execution by indexing content embeddings, retrieving candidate content, and/or executing retrieval models based on dataset-specific retrieval parameters. That is, the retrieval system 310 can reference a structured indexing function to load and store document embeddings, facilitating retrieval queries based on content similarity. The retrieval system 310 can execute retrieval models specified in the configuration dataset 302, allowing retrieval pipelines to be dynamically implemented based on dataset attributes. The reranking system 308 can receive retrieved content and transmit an inference request to the host system 316, via the retrieval system 310, to execute a ranking model to reorder candidate content before forwarding results to the response generation system 314.

The retrieval system 310 can execute retrieval models referenced in the configuration dataset 302 based on inference requests transmitted to the host system 316. The retrieval models executed within model(s) 318 can process retrieval requests corresponding to query embeddings generated by the embedding system 306. The retrieval system 310 can execute retrieval models based on retrieval configurations (e.g., retrieval pipeline definitions such as, retrieval model selection, indexing strategies, similarity function settings, retrieval depth parameters, and/or any retrieval ranking function) specifying retrieval scoring functions and ranking criteria. The retrieval system 310 can apply YAM L-based pipeline definitions and/or any other structured retrieval framework to structure retrieval processes, integrating embedding-based retrieval with ranking functions for query-based candidate selection. The retrieval system 310 can load retrieval indexing pipelines, allowing document embeddings to be indexed and stored for retrieval-based processing. Additionally, the retrieval system 310 can facilitate indexing operations asynchronously, allowing parallel insertions into the vector database 312 to improve retrieval performance across different evaluation datasets (e.g., the evaluation dataset 304).

The retrieval system 310 can process retrieval requests based on retrieval configurations defined in the configuration dataset 302. The retrieval configurations can specify retrieval model selection, indexing strategies, query processing logic, and/or retrieval ranking functions. The retrieval system 310 can execute retrieval models by transmitting inference requests to the host system 316 to retrieve candidate content. That is, retrieval pipelines can be dynamically structured based on dataset-specific configurations, facilitating retrieval evaluation across multiple model architectures. The retrieval system 310 can update retrieval execution parameters based on retrieval model performance evaluations, integrating retrieval performance metrics (e.g., recall at K (R@K), normalized discounted cumulative gain at K (NDCG@K)) into retrieval scoring functions (e.g., applied by the analysis system 320). The retrieval system 310 can update retrieval configurations based on evaluation dataset 304 properties. In some implementations, the retrieval system 310 can perform parallel indexing operations using the vector database 312.

The host system 316 can receive inference requests from the response generation system 314, the embedding system 306, the reranking system 308, and/or the retrieval system 310. The inference requests can correspond to executing AI models (e.g., model(s) 318) to generate embeddings, retrieve candidate content, rank retrieved content, and/or generate a response. That is, the host system 316 can execute at least one model from model(s) 318 in response to inference requests received from other components of the system 300. The host system 316 can transmit model outputs back to the requesting system, facilitating retrieval, ranking, embedding generation, and/or response generation based on the executed inference. The host system 316 can manage inference execution based on workload distribution and model-specific execution parameters.

The response generation system 314 can transmit an inference request to the host system 316 to execute a large language model (LL M) from model(s) 318. That is, the response generation system 314 can request execution of an LLM to generate a response based on retrieved candidate content and/or an input query. The host system 316 can perform an LLM inference operation and return the generated response to the response generation system 314. In some implementations, the response generation system 314 can update the prompt formatting, concatenate retrieved content with the input query, and/or transmit a structured input to the host system 316. Additionally, the response generation system 314 can update the response generation by applying decoding operations before transmitting the final response for evaluation.

The response generation system 314 can apply retrieved and ranked candidate content as input to a third AI model (e.g., LLM), executed via the host system 316, to generate an output. That is, the response generation system 314 can transmit an inference request to the host system 316, specifying a response generation model execution request referencing configuration parameters in the configuration dataset 302. The host system 316 can invoke an LLM from model(s) 318, process the retrieved content and input query, and generate a structured response. The response generation system 314 can receive the generated response and update output processing by applying post-processing functions, updating prompt formatting, and/or integrating retrieval-augmented response generation techniques.

In some implementations, the response generation system 314 can perform a retrieval-augmented generation pipeline by transmitting inference requests to the host system 316 to process retrieved candidate content and generate text. The response generation system 314 can execute text generation operations (e.g., retrieval-augmented LLM inference, structured response synthesis) based on retrieved content. The retrieval system 310 can process retrieval logic separately from the response generation system 314, referencing stored retrieval configurations for candidate selection. The response generation system 314 can perform inference operations (e.g., LLM-based response generation, retrieval-integrated answer synthesis) based on structured retrieval outputs.

The response generation system 314 can apply the at least one candidate content and the at least one query as input to a third AI model of the pipeline to generate an output. That is, the response generation system 314 can execute an inference request to the host system 316. For example, the model(s) 318 can process the input query and retrieved content to generate a structured response. The third AI model can include a transformer-based LLM (e.g., decoder-only LLM, retrieval-augmented generation (RAG) model, instruction-tuned LLM) that synthesizes a response by incorporating retrieved information with learned representations. The response generation system 314 can concatenate retrieved candidate content with the query, tokenize the combined input, and/or transmit the structured input to the host system 316 for execution. The host system 316 can return the generated response to the response generation system 314. For example, the output can be post-processed for formatting updates and evaluation alignment.

The response generation system 314 can transmit generated responses to the analysis system 320 for evaluation processing based on corresponding ground truth data. That is, the response generation system 314 can request evaluation of generated outputs by specifying performance validation parameters. For example, the analysis system 320 can compare generated responses to reference answers in the evaluation dataset 304. The analysis system 320 can compute response accuracy metrics (e.g., answer similarity, semantic coherence, response fluency, context recall) to determine alignment between generated outputs and ground truth annotations. The response generation system 314 can request evaluation results from the analysis system 320. For example, the structured evaluation metrics can be returned to assess response quality. Additionally, the response generation system 314 can update response generation configurations based on evaluation feedback, updating prompt construction, retrieval integration, and inference parameters for improved response synthesis.

The analysis system 320 can evaluate generated responses by computing performance metrics based on retrieved content and corresponding ground truth data. That is, the response generation system 314 can transmit an evaluation request to the analysis system 320, specifying validation parameters for assessing generated responses. The analysis system 320 can compare generated responses to reference answers stored in the evaluation dataset 304, computing evaluation metrics (e.g., answer similarity, context recall, response fluency, and normalized discounted cumulative gain (NDCG@K)). The analysis system 320 can store evaluation results in a structured format and/or transmit computed evaluation metrics to the response generation system 314.

Generally, the analysis system 320 can process retrieval effectiveness metrics (e.g., recall at K (R@K), normalized discounted cumulative gain (NDCG@K), retrieval precision). The analysis system 320 can compute retrieval performance based on retrieved candidate content, evaluating retrieval effectiveness across different retriever configurations. The retrieval system 310 can process retrieval evaluation results from the analysis system 320, updating retrieval scoring parameters based on retrieval ranking distributions. The retrieval system 310 can reference structured evaluation outputs to update retrieval execution logic, updating retrieval functions for candidate selection.

In some implementations, the embedding system 306 can transmit an evaluation request to the analysis system 320, specifying an embedding model configuration, benchmarking parameters, and/or dataset properties for retrieval effectiveness assessment. That is, the embedding system 306 can invoke retrieval-based evaluation by requesting embedding performance metrics corresponding to retrieval precision, recall, and/or ranking impact. The analysis system 320 can perform embedding-based retrieval evaluations by comparing generated embeddings against stored document embeddings, computing retrieval effectiveness metrics such as mean reciprocal rank (MRR), recall at K (R@K), and/or cosine similarity distributions. The analysis system 320 can store embedding evaluation metrics in a structured repository and/or return performance results to the embedding system 306 for retrieval configuration updates.

In some implementations, the reranking system 308 can transmit an evaluation request to the analysis system 320, specifying a ranking model configuration, ranking criteria, and/or dataset properties for ranking effectiveness analysis. That is, the reranking system 308 can request ranking performance evaluation based on ranked candidate content, computing ranking accuracy against annotated relevance scores. The analysis system 320 can execute ranking-based evaluations by applying ranking functions to retrieved content and computing ranking consistency metrics such as precision at K (P@K), NDCG@K, and/or ranking confidence distributions. The analysis system 320 can store ranking evaluation metrics in a structured format and/or return computed ranking effectiveness scores to the reranking system 308 for ranking model updates.

Generally, the analysis system 320 can determine and/or otherwise compute retrieval and response evaluation metrics based on structured evaluation processes. That is, the analysis system 320 can process retrieval effectiveness metrics, ranking evaluation scores, and/or response generation assessments based on structured evaluation datasets. The analysis system 320 can determine retrieval performance based on scoring functions referencing retrieval accuracy, ranking confidence, and/or response relevance. The analysis system 320 can generate evaluation reports for retrieval and ranking operations. In some implementations, the analysis system 320 can compare retrieved content and generated responses against ground truth annotations using evaluation tools (e.g., pytrec_eval and ragas). The analysis system 320 can apply pytrec_eval to compute retrieval ranking metrics (e.g., recall@K, normalized discounted cumulative gain (NDCG@K), and mean reciprocal rank (MRR)) by assessing how well retrieved content matches reference rankings. The analysis system 320 can apply ragas to compute response generation metrics (e.g., answer faithfulness, semantic similarity, and response coherence) by evaluating the generated responses against ground truth annotations. The analysis system 320 can reference scoring outputs to assess retrieval scoring distributions, ranking order consistency, and/or response fidelity. The analysis system 320 can store evaluation results in a structured repository.

The system 300 can execute multiple pipeline modeling jobs to assess retrieval, ranking, and/or response generation across different configurations. That is, the retrieval system 310 can update retrieval logic, update indexing functions, and/or execute retrieval models under different configurations to analyze performance variations. The embedding system 306 can generate embeddings using different embedding models (e.g., dense, sparse, contrastive) based on configuration parameters, update vector representations for content records in the vector database 312, and/or update embedding generation settings based on retrieval performance metrics. The reranking system 308 can apply different ranking functions to assess ranking impact, and/or the response generation system 314 can compare response synthesis effectiveness across various LLM configurations. The analysis system 320 can evaluate pipeline execution performance across different configurations, analyzing both, retrieval accuracy, ranking accuracy, and/or final answer quality. The host system 316 can execute multiple configurations of model(s) 318, processing different retrieval, ranking, and/or response generation models based on configuration parameters of the configuration dataset 302.

The system 300 can receive user requests to query pipeline modeling status and return execution details in a structured format. That is, a user device can transmit a status request to retrieve execution logs, evaluation summaries, and/or ranking results. The system 300 can process the request by querying execution records stored by the analysis system 320, returning structured job status reports (e.g., JSON). The retrieval system 310 can provide intermediate retrieval accuracy metrics, the reranking system 308 can provide ranking effectiveness summaries, and the response generation system 314 can return generated response evaluation scores. The host system 316 can return structured evaluation results to the user, facilitating pipeline performance assessment.

The retrieval system 310 can update retrieval configurations dynamically based on evaluation results. That is, retrieval models executed within model(s) 318 can be updated based on retrieval performance metrics, updating retrieval depth parameters, similarity function selections, and/or retrieval scoring thresholds. The reranking system 308 can update ranking logic based on ranking model effectiveness, updating ranking weight distributions, scoring functions, and/or metadata-based ranking constraints. The response generation system 314 can update response generation techniques based on response evaluation results, updating prompt engineering logic, retrieval integration techniques, and/or output decoding strategies. The system 300 can continuously update pipeline execution parameters based on retrieval, ranking, and/or response generation effectiveness.

In some implementations, the retrieval system 310 can reference retrieval indexing structures supporting modified data handling processes, such as deprecating in-memory storage methods and updating dataset path references for consistency across evaluation processes. The embedding system 306 can process embedding generation requests using improved execution logic, increasing batch processing sizes and providing multi-threaded API calls for embedding and indexing. Additionally, the system 300 can reuse code logic for retrieval and retrieval-augmented generation (RAG) evaluations, providing modular execution structures for launcher code, evaluation functions, and/or dataset conversion utilities. The system 300 can integrate caching mechanisms for embedding storage and retrieval. In some implementations, the system 300 can perform unit tests and structured validation processes to improve retrieval accuracy, indexing consistency, and/or query response efficiency. The analysis system 320 can support additional testing configurations, facilitating structured assessment of default evaluation configurations and execution parameters. In some implementations, the response generation system 314 can incorporate dataset-based evaluation improvements, such as processing sample test cases for validating response synthesis across retrieval and ranking variations.

### Example Language Models

In at least some implementations, language models, such as large language models (LLMs), small language models (SLMs), vision language models (VLMs), multi-modal language models (MMLMs), and/or other types of generative artificial intelligence (AI) can be implemented. Generally, the language models can process retrieved content and input queries to generate outputs within a retrieval-augmented generation (RAG) pipeline. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/SLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLM/SLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMS/SLMs/VLMs/MMLM s/etc. can also include one or more diffusion block(s) (e.g., denoisers). The LLMs/SLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/SLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLM/SLMs/VLMs/MMLMs/etc.

In various implementations, the LL M/SLMs/VLMs/MMLMs/etc. can be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/SLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/SLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLM/SLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/SLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLM s/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 4A is a block diagram of an example generative language model system 400 suitable for use in implementing at least some implementations of the present disclosure. Generally, the example generative language model system 400 can process retrieved content and input queries to generate outputs within a RAG pipeline. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which can include an LLM, a SLM, a VLM, a multi-modal LM, etc.).

At a high level, the input processor 405 can receive an input 401 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 430 (e.g., LLM/SLM/VLM/MMLM/etc.). In some implementations, the input 401 includes plain text in the form of one or more sentences, paragraphs, and/or documents. Additionally, or alternatively, the input 401 can include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 can combine text (or can omit text) with image data, audio data, video data, design data, USD data, and/or other types of input data, such as but not limited to those described herein. Taking raw input text as an example, the input processor 405 can prepare raw input text in various ways. For example, the input processor 405 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 can remove stopwords to reduce noise and focus the generative LM 430 on more meaningful content. The input processor 405 can apply text normalization, for example, by converting all characters to lowercase, removing accents, and/or or handling special cases like contractions or abbreviations to ensure consistency. These are just a few examples, and other types of input processing can be applied.

In some implementations, a RAG component 492 (which can include one or more RAG models, and/or can be performed using the generative LM 430 itself) can be used to retrieve additional information to be used as part of the input 401 or prompt. RAG can be used to enhance the input to the LLM/SLM/VLM/MMLM/etc. with external knowledge, so that answers to specific questions or queries or requests are more relevant—such as in a case where specific knowledge is required. The RAG component 492 can fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 401 can be generated using the query or input to the model (e.g., a question, a request, etc.) in addition to data retrieved using the RAG component 492. In some implementations, the input processor 405 can analyze the input 401 and communicate with the RAG component 492 (or the RAG component 492 can be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 can retrieve a prior stored conversation history—or at least a summary thereof—and include the prior conversation history along with the current ask/request as part of the input 401 to the generative LM 430.

The RAG component 492 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 492 and the embeddings of the chunks along with the embeddings of the query can be compared to identify the most similar/related embeddings to the query, which can be supplied to the generative LM 430 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/SLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/SLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 492 can implement a plugin, API, user interface, and/or other functionality to perform RAG. For example, a graph RAG plug-in can be used by the LLM/SLM/VLM/MMLM/etc. to run queries against the knowledge graph to extract relevant information for feeding to the model, and a standard or vector RAG plug-in can be used to run queries against a vector database. For example, the graph database can interact with a REST interface plug-in such that the graph database is decoupled from the vector database and/or the embeddings models.

The tokenizer 410 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), allowing the generative LM 430 to understand morphological variations and handle out-of-vocabulary words more effectively. Character-based tokenization represents each character as a separate token, allowing the generative L M 430 to process text at a fine-grained level. The choice of tokenization strategy can depend on factors such as the language being processed, the task at hand, and/or characteristics of the training dataset. As such, the tokenizer 410 can convert the (e.g., processed) text into a structured format according to tokenization schema being implemented in the particular implementation.

The embedding component 420 can use any known embedding technique to transform discrete tokens into (e.g., dense, continuous vector) representations of semantic meaning. For example, the embedding component 420 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 405 can resize the data to a standard size compatible with format of a corresponding input channel and/or can normalize pixel values to a common range (e.g., 0 to 1) to ensure a consistent representation, and the embedding component 420 can encode the image data using any known technique (e.g., using one or more convolutional neural networks (CNNs) to extract visual features). In some implementations in which the input 401 includes audio data, the input processor 405 can resample an audio file to a consistent sampling rate for uniform processing, and the embedding component 420 can use any known technique to extract and encode audio features—such as in the form of a spectrogram (e.g., a mel-spectrogram). In some implementations in which the input 401 includes video data, the input processor 405 can extract frames or apply resizing to extracted frames, and the embedding component 420 can extract features such as optical flow embeddings or video embeddings and/or can encode temporal information or sequences of frames. In some implementations in which the input 401 includes multi-modal data, the embedding component 420 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 can apply an encoded representation of the input 401 to the generative LM 430, and the generative LM 430 can process the encoded representation of the input 401 to generate an output 490, which can include responsive text and/or other types of data.

As described herein, in some implementations, the generative LM 430 can be configured to access or use or capable of accessing or using-plug-ins/APIs 495 (which can include one or more plug-ins, application programming interfaces (APIs), databases, data stores, repositories, etc.). For example, for certain tasks or operations that the generative LM 430 is not ideally suited for, the model can have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 495 to the plug-in/API 495, the plug-in/API 495 can process the information and return an answer to the generative LM 430, and the generative LM 430 can use the response to generate the output 490. This process can be repeated—e.g., recursively—for any number of iterations and using any number of plug-ins/APIs 495 until an output 490 that addresses each ask/question/request/process/operation/etc. from the input 401 can be generated. As such, the model(s) can not only rely on its own knowledge from training on a large dataset(s) and/or from data retrieved using the RA G component 492, but also on the expertise or optimized nature of one or more external resources—such as the plug-ins/APIs 495.

FIG. 4B is a block diagram of an example implementation in which the generative LM 430 includes a transformer encoder-decoder. Generally, the generative LM 430 can process retrieved content and input queries to generate outputs within a RAG pipeline. For example, assume input text such as “Who discovered gravity” is tokenized (e.g., by the tokenizer 410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 440 can convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 can generate a first token, and the generation mechanism 455 can apply the generated token as an input during a second pass. The process can repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 can output some decoded (e.g., vector) representation of the input being applied during a particular pass. The classifier 450 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 can select or sample a word or token based on a corresponding predicted probability (e.g., select the word with the highest predicted probability) and append it to the output from a previous pass, generating each word or token sequentially. The generation mechanism 455 can repeat the process, triggering successive decoder inputs and corresponding predictions until selecting or sampling a symbol or token that represents the end of the response, at which point, the generation mechanism 455 can output the generated response.

FIG. 4C is a block diagram of an example implementation in which the generative LM 430 includes a decoder-only transformer architecture. For example, the decoder(s) 460 of FIG. 4C can operate similarly as the decoder(s) 445 of FIG. 4B except each of the decoder(s) 460 of FIG. 4C omits the encoder-decoder self-attention layer (since there is no encoder in this implementation). As such, the decoder(s) 460 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 460. As with the decoder(s) 445 of FIG. 4B, each token (e.g., word) can flow through a separate path in the decoder(s) 460, and the decoder(s) 460, a classifier 465, and a generation mechanism 470 can use auto-regression to sequentially generate one token at a time until predicting a symbol or token that represents the end of the response. The classifier 465 and the generation mechanism 470 can operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. Generally, the generative LM 430 can process retrieved content and input queries to generate outputs within a RAG pipeline. These and other architectures described herein are meant simply as examples, and other suitable architectures can be implemented within the scope of the present disclosure.

### Example Computing Device

FIG. 5 is a block diagram of an example computing device(s) 500 suitable for use in implementing some implementations of the present disclosure. Generally, the example computing device(s) 500 can store datasets and embeddings and/or vectors used in a RAG pipeline. Computing device 500 can include an interconnect system 502 that directly or indirectly couples the following devices: memory 504, one or more central processing units (CPU s) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 can comprise one or more virtual machines (VMs), and/or any of the components thereof can comprise virtual components (e.g., virtual hardware components). For non-limiting examples, one or more of the GPUs 508 can comprise one or more vGPUs, one or more of the CPUs 506 can comprise one or more vCPUs, and/or one or more of the logic units 520 can comprise one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device 500. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In implementations, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPU s through a switch (e.g., using NV Switch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In implementations, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRa WAN, SigFox, etc.), and/or the Internet. In one or more implementations, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one implementations of the present disclosure. Generally, the example data center 600 can facilitate computing infrastructure for executing retrieval, ranking, and/or generation models in a RAG pipeline. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one implementation, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) can correspond to a server having one or more of the above-mentioned computing resources. In addition, in some implementations, the node C.R.s 616(1)-6161(N) can include one or more virtual components, such as vGPUs, vCPUs, and/or the like, and/or one or more of the node C.R.s 616(1)-616(N) can correspond to a virtual machine (VM).

In at least one implementation, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory or storage resources that can be configured or allocated to support one or more workloads. In at least one implementation, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one implementation, resource orchestrator 612 can include a software design infrastructure (SDI) management entity for the data center 600. The resource orchestrator 612 can include hardware, software, or some combination thereof.

In at least one implementation, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can use distributed file system 638 for large-scale data processing (e.g., “big data”). In at least one implementation, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one implementation, clustered or grouped computing resources can include grouped computing resource 614 at data center infrastructure layer 610. The resource manager 636 can coordinate with resource orchestrator 612 to manage these mapped or allocated computing resources.

In at least one implementation, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one implementation, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 600. In at least one implementation, trained or deployed machine learning models corresponding to one or more neural networks can be used to infer or predict information using resources described above with respect to the data center 600 by using weight parameters calculated through one or more training techniques, such as but not limited to those described herein.

In at least one implementation, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to:
obtain a configuration dataset and an evaluation dataset, the configuration dataset identifying a pipeline and the evaluation dataset comprising a set of content and at least one query;
generate, using a first artificial intelligence (AI) model of the pipeline, a plurality of embeddings of the set of content;
retrieve, from a vector database, at least one candidate content from the plurality of embeddings based at least on a similarity metric between the at least one candidate content and the at least one query;
determine a performance metric based at least on the retrieved at least one candidate content; and
provide the performance metric.

2. The system of claim 1, wherein the configuration dataset identifies at least one configuration template to implement the pipeline, wherein the first AI model is identified from the at least one configuration template.

3. The system of claim 1, wherein the one or more processors are to:
store the plurality of embeddings in the vector database, wherein generating the plurality of embeddings comprises generating a vector index for the set of content.

4. The system of claim 3, wherein the one or more processors are to:
generate, using the first AI model, a plurality of query embeddings representing the at least one query, wherein the at least one candidate content is retrieved based at least on the similarity metric determined between the plurality of query embeddings and the plurality of embeddings stored in the vector database.

5. The system of claim 1, wherein the at least one candidate content comprises a plurality of candidate content, and wherein the one or more processors are to:
update, using a second AI model, an order of the plurality of candidate content based at least on ranking the plurality of candidate content using at least one of (i) a vector similarity metric, (ii) query relevance metric, (iii) retrieval confidence metric, or (iv) aggregation metric.

6. The system of claim 5, wherein the one or more processors are to:
apply the at least one candidate content and the at least one query as input to a third AI model of the pipeline to cause the third AI model to generate an output, wherein generating the performance metric is further based on the output and corresponding ground truth data.

7. The system of claim 6, wherein the one or more processors are to:
generate, based on the configuration dataset, a plurality of pipeline configurations, at least one pipeline configuration of the plurality of pipeline configurations comprising at least one of the first AI model, the second AI model, or the third AI model;
perform at least one pipeline modeling job corresponding to at least one of the plurality of pipeline configurations;
determine, for the at least one pipeline modeling job, the performance metric corresponding to the retrieved at least one candidate content or the output generated by the third AI model; and
update at least one of the plurality of pipeline configurations based at least on the performance metric across the plurality of pipeline configurations.

8. The system of claim 1, wherein the one or more processors are to:
receive, from a user device, a status request corresponding to a pipeline modeling job;
determine a status of the pipeline modeling job; and
provide, to the user device, the status.

9. The system of claim 1, wherein the one or more processors are to execute operations comprising:
a system for performing one or more retrieval-augmented generation (RAG) pipelines;
a system for tuning one or more processing architectures;
a system for updating one or more processing configurations;
a system for implementing distributed or concurrent processing operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system incorporating one or more virtual machines (VMs);
a system implemented at least partially in a data center; or
a system implemented at least partially using cloud computing resources.

10. One or more processors comprising processing circuitry to:
obtain a configuration dataset and an evaluation dataset, the configuration dataset identifying a pipeline and the evaluation dataset comprising a set of content and at least one query;
generate, using a first artificial intelligence (AI) model of the pipeline, a plurality of embeddings of the set of content;
retrieve, from a vector database, at least one candidate content from the plurality of embeddings based at least on a similarity metric between the at least one candidate content and the at least one query;
determine a performance metric based at least on the retrieved at least one candidate content; and
provide the performance metric.

11. The one or more processors of claim 10, wherein the configuration dataset identifies at least one configuration template to implement the pipeline, wherein the first AI model is identified from the at least one configuration template.

12. The one or more processors of claim 10, wherein the processing circuitry to:
store the plurality of embeddings in the vector database, wherein generating the plurality of embeddings comprises generating a vector index for the set of content.

13. The one or more processors of claim 12, wherein the processing circuitry to:
generate, using the first AI model, a plurality of query embeddings representing the at least one query, wherein the at least one candidate content is retrieved based at least on the similarity metric determined between the plurality of query embeddings and the plurality of embeddings stored in the vector database.

14. The one or more processors of claim 10, wherein the at least one candidate content comprises a plurality of candidate content, and wherein the processing circuitry to:
update, using a second AI model, an order of the plurality of candidate content based at least on ranking the plurality of candidate content using at least one of (i) a vector similarity metric, (ii) query relevance metric, (iii) retrieval confidence metric, or (iv) aggregation metric.

15. The one or more processors of claim 14, wherein the processing circuitry to:
apply the at least one candidate content and the at least one query as input to a third AI model of the pipeline to cause the third AI model to generate an output, wherein generating the performance metric is further based on the output and corresponding ground truth data.

16. The one or more processors of claim 15, wherein the processing circuitry to:
generate, based on the configuration dataset, a plurality of pipeline configurations, at least one pipeline configuration of the plurality of pipeline configurations comprising at least one of the first AI model, the second AI model, or the third AI model;
perform at least one pipeline modeling job corresponding to at least one of the plurality of pipeline configurations;
determine, for the at least one pipeline modeling job, the performance metric corresponding to the retrieved at least one candidate content or the output generated by the third AI model; and
update at least one of the plurality of pipeline configurations based at least on the performance metric across the plurality of pipeline configurations.

17. The one or more processors of claim 10, wherein the processing circuitry to:
receive, from a user device, a status request corresponding to a pipeline modeling job determine a status of the pipeline modeling job; and
provide, to the user device, the status.

18. A method, comprising:
obtaining, by one or more processors, a configuration dataset and an evaluation dataset, the configuration dataset identifying a pipeline and the evaluation dataset comprising a set of content and at least one query;
generating, by the one or more processors using a first artificial intelligence (AI) model of the pipeline, a plurality of embeddings of the set of content;
retrieving, by the one or more processors from a vector database, at least one candidate content from the plurality of embeddings based at least on a similarity metric between the at least one candidate content and the at least one query;
determining, by the one or more processors, a performance metric based at least on the retrieved at least one candidate content; and
providing, by the one or more processors, the performance metric.

19. The method of claim 18, wherein the configuration dataset identifies at least one configuration template to implement the pipeline, wherein the first AI model is identified from the at least one configuration template.

20. The method of claim 18, further comprising:
storing, by the one or more processors, the plurality of embeddings in the vector database, wherein generating the plurality of embeddings comprises generating a vector index for the set of content.
